(19) United States
(12) Patent Application Publication
(10) Pub. No.: US 2009/0212071 A1
(43) Pub. Date: Aug. 27, 2009

(54) MATERIAL STORAGE AND DISPENSING PACKAGES AND METHODS

(75) Inventors: Glenn M. Tom, Bloomington, MN (US); John R. Kingery, Eden Prairie, MN (US); Kevin T. O'Dougherty, Arden Hills, MN (US); Kirk Mikkelsen, Carver, MN (US); Michele Alberg, Minnetonka, MN (US); Patrick M. Olson, Victoria, MN (US); Tim Hoyt, Prior Lake, MN (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 11/912,629

(22) PCT Filed: Apr. 25, 2006
(86) PCT No.: PCT/US06/15605

§ 371 Date: Dec. 23, 2008

Related U.S. Application Data
(60) Provisional application No. 60/674,578, filed on Apr. 25, 2005.
(60) Provisional application No. 60/761,608, filed on Jan. 24, 2006.

(51) Int. Cl. B65D 81/18; B65D 37/00; B65D 81/20; B32B 3/26; B32B 27/34; B32B 27/32; B65D 35/28

(52) U.S. Cl. 222/95; 428/316.6; 428/476.9; 428/220; 222/105; 222/1

(57) ABSTRACT

Packages and methods for storage and dispensing of materials, e.g., high purity liquid reagents and chemical mechanical polishing compositions used in the manufacture of microelectronic device products, including containment structures and methods adapted for pressure-dispensing of high-purity liquids. Liner packaging of liquid or liquid-containing media is described, in which zero or near-zero head space conformations are employed to minimize adverse effects of particle generation, formation of bubbles and degradation of contained material.

### CROSS-REFERENCE TO RELATED APPLICATIONS

The subject matter of the present application relates to and encompasses the disclosure of U.S. provisional patent application No. 60/674,578 filed on Apr. 25, 2005 in the names of Glenn M. Tom, et al., for “ZERO HEAD SPACE/MINIMUM HEAD SPACE LINER-BASED LIQUID STORAGE AND DISPENSING SYSTEMS ADAPTED FOR PRESSURE DISPENSING,” and U.S. provisional application No. 60/761,608 filed on Jan. 24, 2006 in the names of Glenn M. Tom, et al. for “MATERIAL STORAGE AND DISPENSING PACKAGES AND METHODS.” U.S. provisional patent application No. 60/674,578 was co-filed on Apr. 25, 2005 with related U.S. provisional patent application No. 60/674,579 filed Apr. 25, 2005 in the names of Minna Hovinen, et al., for “LINER-BASED LIQUID STORAGE AND DISPENSING SYSTEMS WITH EMPTY DETECTION CAPABILITY,” and U.S. provisional patent application No. 60/674,577 filed Apr. 25, 2005 in the names of Weihua Wang, et al., for “APPARATUS AND PROCESS FOR STORAGE AND DISPENSING OF CHEMICAL REAGENTS AND COMPOSITIONS.” The disclosures of all such provisional applications are hereby incorporated herein by reference in their respective entireties.

### FIELD OF THE INVENTION

The present invention relates generally to material containment systems that are useful for storage and dispensing of chemical reagents and compositions, e.g., high purity liquid reagents and chemical mechanical polishing compositions used in the manufacture of microelectronic devices, and in various embodiments adapted for pressure dispensing of liquids or other fluids.

### DESCRIPTION OF THE RELATED ART

In many industrial applications, chemical reagents and compositions are required to be supplied in a high purity state, and specialized packaging has been developed to ensure that the supplied material is maintained in a pure and suitable form, throughout the package fill, storage, transport, and ultimate dispensing operations.

In the field of microelectronic device manufacturing, the need for suitable packaging is particularly compelling for a wide variety of liquids and liquid-containing compositions, since any contaminants in the packaged material, and/or any ingress of environmental contaminants to the contained material in the package, can adversely affect the microelectronic device products that are manufactured with such liquids or liquid-containing compositions, rendering the microelectronic device products deficient or even useless for their intended use.

As a result of these considerations, many types of high-purity packaging have been developed for liquids and liquid-containing compositions used in microelectronic device manufacturing, such as photoresists, etchants, chemical vapor deposition reagents, solvents, wafer and tool cleaning formulations, chemical mechanical polishing compositions, etc.

One type of high-purity packaging that has come into such usage includes a rigid outer pack containing a liquid or liquid-based composition, or other material, in a flexible liner or bag that is secured in position in the rigid outer pack by retaining structure such as a lid or cover. Such packaging is commonly and variously referred to as “bag-in-box,” “bag-in-container,” or “bag-in-drum” packaging, depending on the specific form of the rigid outer pack. The rigid outer pack of the packaging may for example be formed of a high-density polyethylene or other polymer or metal, and the liner may be provided as a pre-cleaned, sterile collapsible bag of a polymeric film material, such as polytetrafluoroethylene (PTFE), low-density polyethylene, polyethylene-based multilayer laminates, PTFE-based multilayer laminates, polyurethane, or the like, selected to be inert to the contained liquid or liquid-based material to be contained in the liner. Packaging of such type is commercially available under the trademark NOWPAK from ATMI, Inc. (Danbury, Conn., USA).

In the dispensing operation involving such liner packaging of liquids and liquid-based compositions, the liquid is dispensed from the liner by connecting a dispensing assembly including a dip tube to a port of the liner, with the dip tube immersed in the contained liquid. After the dispensing assembly has been thus coupled to the liner, fluid pressure is applied on the exterior surface of the liner, so that it progressively collapses and forces liquid through the dispensing assembly for discharge to associated flow circuitry to an end-use site. Alternatively, a negative pressure can be applied to the outlet of the liner or to a dispensing assembly connected thereto, in order to draw the liquid out of the package.

When liquid materials are shipped in liner-based packages of such type, a gas space is generally maintained above the liquid, as a headspace gas to accommodate thermal expansion and contraction of the liquid without excessive mechanical strain being placed on the container.

In consequence, however, as the liquid is agitated during transport and other movement of the package, bubbles can become entrained in the packaged liquid. If the liquid material has high viscosity, such bubbles, particularly small ones, can persist in the liquid material for a very long time. Such bubbles are extremely deleterious in use of the liquid, since the entrained bubbles are treated as particles by particle analyzers typically utilized in quality assurance sampling, and in actual dispensing operations. The use of such particle analyzers is intended to monitor the purity of the liquid for its intended purpose. An erroneous particle count, due to the presence of entrained microbubbles, can result in the rejection or reworking of the liquid material that is in fact of a desired purity character.

Additionally, the presence of microbubbles in the liquid medium may be problematic from the standpoint of the presence of gas therein. The entrained gas may interfere with subsequent processing of the liquid material, or it may adversely affect a product manufactured with the liquid material, and render it deficient or even useless for its intended purpose. Accordingly, elimination of bubble formation in the liner-packaged liquid material is important in relation to the accuracy and reliability of particle counts determine for the material, as well as for efficient processing as well as manufacturing of end products using the liquid material.

Considering now the liner itself, the liner desirably is characterized by low permeability, to limit the penetration of ambient gases through the liner into the liquid therein. High permeability liners result in increased contact area for gas penetration and contact with the liquid material contained in the liner. Accordingly, liner film materials, having superior barrier properties against gases in the ambient environment of the liner, are or may be critical to the utilization of liner-based packaging for containment of liquid materials that are adversely affected by such ambient gases.

Another characteristic of liners that is of primary importance in many applications is the particle-generating character of the liner, viz., the susceptibility of the liner to shed particles into the liquid material contained therein, e.g., under conditions of expansion and contraction of the liner, flexing and translational movement of the liner, etc. For purposes of maintaining the quality and purity of the liquid material in the liner, it is desirable to minimize, and preferably eliminate, such particle shedding by the liner. As a result, efforts have been focused on the development of liner film materials that are particle shedding-resistant.

A number of liners are commercially available for liner-based packaging of a wide variety of materials. One such liner is commercially available from ATMI, Inc. (Danbury, Conn.) under the trademark ULTRA, which includes polytetrafluoroethylene as a film material. Such liner is characterized by extremely low particle counts and thus superior particle shedding-resistance, as well has superior chemical inertness in consequence of its polytetrafluoroethylene film material.

Another liner product is commercially available from ATMI, Inc. (Danbury, Conn.) under the trademark N400 (formerly FX), which is fabricated of a multilayer laminate and is characterized by extremely low gas permeation rates as well as superior inertness as a result of the use of specially formulated polyethylene-based film materials in the laminate.

The aforementioned polytetrafluoroethylene film-containing liners have found widespread commercial success. In many applications, however, it is desirable to effect the dispensing operation by application of pressure on the exterior surface of the liner to progressively compress and compact the liner and thereby effect discharge of the liquid material from the liner, as discussed above. In such applied-pressure dispensing operations, the inherent permeability of polytetrafluoroethylene allows the pressurizing gas to penetrate the polytetrafluoroethylene film, thereby creating a higher probability of microbubble formation in the liquid material contained in the liner.

In general, film materials that have been utilized in fabrication liners vary widely in their permeability and other physical and chemical properties. The art has implemented a variety of multilayer films in the fabrication of liners, in attempts to optimize the overall characteristics of the liner. As mentioned above, polytetrafluoroethylene has been utilized for reasons of its chemical inertness, e.g. in the aforementioned ULTRA liner. Ethylene vinyl alcohol (EVOH) and nylon have also been utilized due to their very low permeation constants, e.g., in the aforementioned N400 (formerly FX) multilayer laminate including such materials, as well as polyethylene. The N400 laminate, while affording good performance properties in many liquid containment applications, may not be preferred in other applications, since (i) the inner layer of such laminate is polyethylene, which is not as chemically inert as other materials, e.g., polytetrafluoroethylene, (ii) polyethylene cannot be welded to polytetrafluoroethylene, (iii) air trapped between the liner layers represents a virtual leak and (iv) the EVOH film in such laminate, although it provides a good barrier to nitrogen, does not provide a superior moisture barrier.

A problem related to the foregoing issue of permeation barrier characteristics of liner films, is dissolution of penetrated gases in the liquid material. The occurrence of permeation of pressurized gases through the liner will invariably result in some dissolution of gas in the liquid material, depending on the solubility of the gas and its partial pressure and concentration in the headspace gas. Such dissolution of gas is particularly prone to occur during pressure-dispensing of liquid from the liner. The resulting dissolved gas thereafter may form bubbles in the liquid material, as the liquid material is dispensed and encounters decreased pressure conditions in downstream flow circuitry and process equipment, relative to the pressure-dispensing conditions that effected gas dissolution in the first instance. These bubbles may in turn adversely affect the processing of the liquid material and the products manufactured using such liquid material.

For example, in the pressure-dispensing of materials such as photoresists, top anti-reflective coatings (TARCs) and bottom anti-reflective coatings (BARCs), the formation of microbubbles having a size in a range of 0.1 the 20 μm is a source of potential defects when these materials are deposited on wafers. These materials are typically filled into containers in a gas-saturated condition (e.g., saturated with air). If the container then is pressurized, more gas will enter solution. In liner-based packages having headspace gas overlying the liquid material, the gas from the headspace will also dissolve into the liquid material if the annular space between the liner and the associated rigid container is pressurized. The dissolved gas then is very prone to desorb from the liquid material when the applied pressure is reduced, such as in dispensing pumps on their fill cycle during the dispensing of the liquid from the liner.

The art continues to seek improvements in packaging of materials, e.g., solids, liquids and liquid-containing compositions, and particuarly in liner-based packaging, including efforts focused on the development of improved liners having low permeabilities and superior chemical inertness, and improvements in liner-based package construction, including coupling arrangements and structure for connecting the liner to package closures and/or flow circuitry for filling of the liner or dispensing of material therefrom.

SJH—stopped here

### SUMMARY OF THE INVENTION

The present invention relates generally to material containment systems that are useful for storage and dispensing of materials such as chemical reagents and compositions, e.g., high purity liquid reagents and compositions such as chemical mechanical polishing compositions used in the manufacture of microelectronic devices.

In one aspect, the invention relates to a fluid storage and dispensing package, comprising:

a vessel having an interior volume;
a liner in said interior volume, arranged to contain a liquid medium;
a flexible, inflatable bladder in said interior volume, said bladder being inflatable with a fluid medium to contact and retain the liner in position when the liner contains a liquid medium; and
a gas removal compartment arranged in restricted fluid penetration communication with said interior volume of said vessel, and adapted to remove gas from the interior volume of the vessel when the liner contains liquid medium and the bladder is inflated.

In a further aspect, the invention relates to fluid storage and dispensing package, comprising a vessel arranged to hold fluid, e.g., liquid, and a movable and/or flexible barrier that is adapted to (i) apply pressure to fluid in the vessel during dispensing to effect pressure dispensing of fluid from the vessel, without deleterious fluid/fluid interactions of the fluid in the vessel with other fluid(s) and (ii) restrict head space of fluid in the vessel during non-dispensing storage of fluid in the vessel.

Another aspect of the invention relates to a container including a liner for storing and/or delivering a liquid medium and an inflatable member arranged to either impart rigidity to the liner or effect dispensing therefrom of the liquid medium.

A still further aspect of the invention relates to a fluid storage and dispensing package, comprising a vessel arranged to hold fluid, e.g., liquid, and a bladder in the vessel in contact with the fluid, wherein the bladder is inflated with an inflation medium and arranged to expand or contract in response to respective contraction or expansion of the fluid in the vessel, so that the bladder compensates for changes in volume of the fluid in the vessel.

Another aspect of the invention relates to a bag-in-bag package, comprising an inner bag of a first flexible, expandable material, an outer bag of a second flexible, expandable material, wherein the inner and outer bags are joined to one another to form an inflatable space therebetween, and further comprising an inflation passage for introducing an inflation fluid into the inflatable space, whereby compressive force is exerted on one of the inner and outer bags to rigidify the package and/or to effect pressure dispensing of fluid therefrom.

A still further aspect of the invention relates to a bag-in-bag package including inflatable compartments that are selectively inflatable and/or fillable, wherein one or more compartment(s) are arranged to contain a fluid medium adapted for dispensed use, and the other or others of the compartment(s) are arranged to be inflated to rigidify the package, with the inflated compartment(s) being adapted to be further inflated at a point of use to effect pressure dispensing of the fluid medium from the compartment(s) containing same.

Another aspect of the invention relates to a liquid medium storage and dispensing package, comprising a container having an interior volume for holding liquid medium, said container including a semi-flexible portion that is shape-shiftable to vary size of said interior volume available to hold the liquid medium, whereby the interior volume is selectively variable between an expanded volumetric state providing a greater head space for said liquid medium and a compacted volumetric state providing a smaller head space for said liquid medium.

A further aspect of the invention relates to a liquid medium storage and dispensing package, comprising a container having an interior volume for holding liquid medium with a head space thereover, said container being constructed and arranged to (i) provide sufficient space in the interior volume to accommodate expansion/contraction effects of said liquid medium, and (ii) avoid production of a saturated pressure equal to or greater than 3 psig (0.21 kg/cm²) in the head space, so that the liquid medium does not saturate to a pressure of 3 psig or greater when mixed and dispensed.

The invention also relates in one aspect to a method of storing and dispensing a high-purity liquid medium, comprising storing the high-purity liquid medium in a liner disposed in a vessel having an interior volume, retaining the liner in a fixed position in said interior volume, with a flexible, inflatable bladder inflated with a fluid medium, and removing gas from the interior volume of the vessel during storage of the high-purity liquid medium in the liner in a fixed position in the vessel, to maintain the high purity of said liquid medium.

An additional aspect of the invention relates to a method of storing and dispensing a fluid, comprising introducing fluid into a vessel, and deploying a movable and/or flexible barrier to (i) apply pressure to fluid in the vessel during dispensing to effect pressure dispensing of fluid from the vessel, without deleterious fluid/fluid interactions of the fluid in the vessel with other fluid(s) and (ii) restrict head space of fluid in the vessel during non-dispensing storage of fluid in the vessel.

Another aspect of the invention relates to a method of storing and dispensing a fluid, comprising introducing fluid into a vessel and disposing a bladder in the vessel in contact with the fluid, wherein the bladder is inflated with an inflation medium and arranged to expand or contract in response to respective contraction or expansion of the fluid in the vessel, so that the bladder compensates for changes in volume of the fluid in the vessel.

A further aspect of the invention relates to a method of packaging a material for subsequent dispensing, comprising providing a bag-in-bag package, comprising an inner bag of a first flexible, expandable material, an outer bag of a second flexible, expandable material, wherein the inner and outer bags are joined to one another to form an inflatable space therebetween, introducing into the inner bag a material for subsequent dispensing, and inflating the inflatable space to exert compressive force on the inner bag, to rigidify the package.

A still further aspect of the invention relates to a method of storing and dispensing a liquid medium, comprising (i) packaging the liquid medium in a container having an interior volume holding the liquid medium, said container including a semi-flexible portion that is shape-shiftable to vary size of said interior volume available to hold the liquid medium, whereby the interior volume is selectively variable between an expanded volumetric state providing a greater head space for said liquid medium and a compacted volumetric state providing a smaller head space for said liquid medium, (ii) positioning the semi-flexible portion to provide the compacted volumetric state for storage of the liquid medium, (iii) after storage in the compacted volumetric state, repositioning the semi-flexible portion to provide the expanded volumetric state for dispensing of the liquid medium, and (iv) dispensing the liquid medium from the container while the interior volume of the container is in the expanded volumetric state.

Yet another aspect of the invention relates to a method of storing a liquid medium, comprising packaging the liquid medium in a container with a head space over the liquid medium, wherein said packaging (i) provides sufficient space in the interior volume to accommodate expansion/contraction effects of said liquid medium, and (ii) avoids production of a saturated pressure equal to or greater than 3 psig (0.21 kg/cm²) in the head space, so that the liquid medium does not saturate to a pressure of 3 psig or greater when mixed and dispensed.

In another aspect, the invention relates to a bag-in-bag package for storage and dispensing of liquid medium, comprising a rigid overpack enclosing an interior volume, having disposed therein a first bag surrounding a second bag, wherein the one of the bags is adapted to hold liquid medium and the other of the bags is inflatable by introduction of externally supplied gas thereinto, to exert compression on the one bag for fixation thereof prior to dispensing, and during dispensing operation is further inflatable to effect pressure dispensing from the one bag.

A further aspect of the invention relates to a pressure-dispense package for storage and dispensing of liquid medium, comprising a vessel adapted to contain liquid medium therein, with an outlet for dispensing liquid medium therefrom, and an inflatable bag disposed in a central region of the vessel, adapted for coupling to an external gas supply for inflation of the bag to effect pressure-dispensing of liquid medium from the vessel through the outlet.

Another aspect of the invention relates to a polymeric film laminate, comprising an inner ply formed of high purity medium density polyethylene, and an outer ply including seven film layers comprising successively a first layer, adjacent the inner ply, of linear low density polyethylene and medium density polyethylene including an anti-block agent, a first tie layer of anhydride-modified polyethylene adjacent the first layer, a first polyamide layer adjacent the anhydride-modified polyethylene tie layer, an EVOH layer adjacent the first polyamide layer, a second layer of polyamide adjacent the EVOH layer on a side thereof opposite the side adjacent the first polyamide layer, a second tie layer of anhydride-modified polyethylene adjacent the second polyamide layer, and a layer of linear low density polyethylene and high density polyethylene including an anti-block agent.

Yet another aspect of the invention relates to a liquid medium-supplied manufacturing system, comprising:

a manufacturing tool adapted to utilize a liquid medium; and
a liquid medium dispensing source joined in flow communication with the manufacturing tool, to dispense the liquid medium thereto;
wherein the liquid medium source comprises a source as described herein.

A further aspect of the invention relates to a method for storage and dispensing of liquid medium, comprising providing a rigid overpack enclosing an interior volume, having disposed therein a first bag surrounding a second bag, filling one of the bags with liquid medium and inflating the other of the bags with gas, to exert compression on the one bag for fixation thereof prior to dispensing, and during dispensing operation further inflating the other of the bags to effect pressure dispensing from the one bag.

In another aspect, the invention relates to a method of storage and dispensing of liquid medium, comprising providing a vessel adapted to contain liquid medium therein, with an outlet for dispensing liquid medium therefrom, and an inflatable bag disposed in a central region of the vessel, and inflating the bag to effect pressure-dispensing of liquid medium from the vessel through the outlet.

A further aspect of the invention relates to a method of manufacturing a product by a process involving utilization of a liquid medium, such method comprising supplying said liquid medium to the process from a liner-based source.

In one aspect, the invention relates to a material containment package, comprising a material containment vessel adapted to contain material potentially susceptible to bubble formation therein, having a headspace associated therewith, and a vacuum applicator adapted to place the headspace under vacuum that is sufficient to reduce bubble formation susceptibility of the material.

Another aspect of the invention relates to a material containment package, comprising a material containment vessel including an interior volume adapted to contain material therein, and a port, and a balloon disposed in the interior volume of the vessel and adapted to be at least partially inflated to accommodate internal pressure changes due to expansion and contraction of material contained in the interior volume.

A further aspect of the invention relates to a material containment package including a first liner having an interior volume adapted to hold a first material therein in a sealed condition, and a second liner having an interior volume adapted to hold the first liner therein, wherein each of the first and second liners has a fitment allowing fluid communication with its interior volume, wherein the fitment of the first liner is coupleable with the fitment of the second liner to form a fitment assembly for the package.

In another aspect, the invention relates to a fitment adapted to be secured to a liner, said fitment comprising an upper generally cylindrical main body portion and a lower outwardly flaring skirt portion defining a flange for liner securement, and a collar intermediate said generally cylindrical main body portion and said outwardly flaring skirt portion.

A further aspect of the invention relates to a fitment assembly including a first fitment comprising an upper generally cylindrical main body portion and a lower outwardly flaring skirt portion defining a flange for liner securement, and a collar intermediate said generally cylindrical main body portion and said outwardly flaring skirt portion, and a second fitment including an upper central axle portion and a lower peripheral flange portion, wherein said upper central axle portion and lower peripheral flange portion circumscribe a central opening, and said second fitment is lockingly engageable with the collar of the first fitment.

In another aspect, the invention relates to a liner-within-a-liner material containment package, comprising a fitment assembly including a first fitment comprising an upper generally cylindrical main body portion and a lower outwardly flaring skirt portion defining a flange for liner securement, and a collar intermediate said generally cylindrical main body portion and said Outwardly flaring skirt portion, and a second fitment including an upper central axle portion and a lower peripheral flange portion, wherein said upper central axle portion and lower peripheral flange portion circumscribe a central opening, and said second fitment is lockingly engageable with the collar of the first fitment, with a first liner secured to said flange of said lower outwardly flaring skirt portion of the first fitment, and a second liner secured to said lower peripheral flange portion of said second fitment, with the first liner inside the second liner.

A composite liner constitutes another aspect of the invention and includes a primary liner attached at an upper end thereof to a fitment providing material introduction and removal communication with an internal volume of the primary liner, and a secondary liner partially penetrating and secured to the primary liner with a penetrated portion of the secondary liner disposed in the internal volume of the primary liner, said secondary liner including a non-penetrating portion exterior of the primary liner, wherein said penetrated portion of the secondary liner is gas-permeable but liquid-impermeable.

Yet another aspect of the invention relates to a material containment package including a vessel containing a liner therein in an interior volume of the vessel, wherein the liner is adapted to contain a liquid or liquid-containing material susceptible to dissolved and/or entrained gas comprising a first gas species, and wherein the interior volume of the vessel outside the liner contains a second gas species different from said first gas species.

In another aspect, the invention relates to a multilayer laminate comprising from innermost to outermost layers in sequence, (i) a layer of polytetrafluoroethylene, (ii) a first tie layer, (iii) a fluoropolymer layer, (iv) a second tie layer, (v) a barrier layer, (vi) a third tie layer and (vii) an abrasion film layer.

A liner comprising the multilayer laminate described above constitutes another aspect of the invention, and a material containment package comprising such liner constitutes yet another aspect of the invention.

A still further aspect of the invention relates to a semiconductor manufacturing facility comprising a reagent source coupled in reagent-supplying relationship with a semiconductor manufacturing tool, wherein said reagent source comprises a package selected from among the aforementioned material containment packages of the invention and the liner-within-a-liner containment package of the invention.

In one method aspect, the invention relates to a method of supplying material susceptible to bubble formation therein, comprising containment of said material under vacuum that is sufficient to reduce bubble formation susceptibility of the material.

A further method aspect of the invention relates to a method of material containment, comprising providing a material containment package including a material containment vessel having an interior volume adapted to contain the material therein, and a port, disposing a balloon in the interior volume of the vessel and at least partially inflating the balloon to accommodate internal pressure changes due to expansion and contraction of the material contained in the interior volume.

A method of material containment constitutes another aspect to the invention, comprising: providing a material containment package including a first liner having an interior volume adapted to hold a first material therein in a sealed condition, and a second liner having an interior volume adapted to hold the first liner therein, wherein each of the first and second liners has a fitment allowing fluid communication with its interior volume, wherein the fitment of the first liner is coupleable with the fitment of the second liner to form a fitment assembly for the package; introducing first material into the interior volume of the first liner through the fitment of the first liner; and introducing second material into the interior volume of the second liner outside the first liner.

In yet another aspect, the invention relates to a method of material containment, comprising: providing a liner-within-a-liner material containment package, comprising a fitment assembly including a first fitment comprising an upper generally cylindrical main body portion and a lower outwardly flaring skirt portion defining a flange for liner securement, and a collar intermediate said generally cylindrical main body portion and said outwardly flaring skirt portion, and a second fitment including an upper central axle portion and a lower peripheral flange portion, wherein said upper central axle portion and lower peripheral flange portion circumscribe a central opening, and said second fitment is lockingly engageable with the collar of the first fitment, with a first liner secured to said flange of said lower outwardly flaring skirt portion of the first fitment, and a second liner secured to said lower peripheral flange portion of said second fitment, with the first liner inside the second liner; introducing a first material into the first liner; and introducing a second material into the second liner outside the first liner.

A method of making a composite liner constitutes yet another aspect of the invention, comprising attaching a primary liner at an upper end thereof to a fitment providing material introduction and removal communication with an internal volume of the primary liner, and securing to the primary liner a secondary liner partially penetrating the primary liner with a penetrated portion of the secondary liner disposed in the internal volume of the primary liner, with said secondary liner including a non-penetrating portion exterior of the primary liner, wherein said penetrated portion of the secondary liner is gas-permeable but liquid-impermeable.

A further aspect of the invention relates to a method of using a composite liner made by the foregoing method, including introducing a liquid into the primary liner, and coupling the non-penetrating portion of the secondary liner to a vacuum source for extraction of dissolved and entrained gas from said liquid.

In a further aspect, the invention relates to a material containment method, comprising providing a package including a vessel containing a liner therein in an interior volume of the vessel, introducing into the liner a liquid or liquid-containing material susceptible to dissolved and/or entrained gas comprising a first gas species, and introducing into the interior volume of the vessel outside the liner a second gas species different from said first gas species.

Another aspect of the invention relates to a method of fabricating a container for a material, including forming a liner from a multilayer laminate, in which the multilayer laminate includes from innermost to outermost layers in sequence, (i) a layer of polytetrafluoroethylene, (ii) a first tie layer, (iii) a fluoropolymer layer, (iv) a second tie layer, (v) a barrier layer, (vi) a third tie layer and (vii) an abrasion film layer.

A method of storing and dispensing a material is contemplated in another aspect of the invention, comprising a use of a package selected from the group consisting of the aforementioned material containment packages of the invention and the liner-within-a-liner containment package of the invention.

A further aspect of the invention relates to a method of manufacturing a semiconductor device, comprising supplying a semiconductor manufacturing reagent to a semiconductor manufacturing tool from a chemical reagent package selected from the group consisting of the aforementioned material containment packages of the invention and the liner-within-a-liner containment package of the invention.

Another aspect of the invention relates to a method of operating a semiconductor manufacturing facility comprising supplying a reagent to a semiconductor manufacturing tool, from a package selected from the group consisting of the aforementioned material containment packages of the invention and the liner-within-a-liner containment package of the invention.

A still further aspect of the invention relates to a method of supplying material for semiconductor manufacturing to a semiconductor manufacturing facility, comprising transporting said material to said semiconductor manufacturing facility in a package selected from the group consisting of the aforementioned material containment packages of the invention and the liner-within-a-liner containment package of the invention.

Another aspect of the invention relates to a method of packaging a material, comprising introducing said material into a package selected from the group consisting of the aforementioned material containment packages of the invention and the liner-within-a-liner containment package of the invention.

In yet another method aspect of the invention, a method of packaging a material includes confining the material in a contained volume using a multilayer laminate comprising from innermost to outermost layers in sequence, (i) a layer of polytetrafluoroethylene, (ii) a first tie layer, (iii) a fluoropolymer layer, (iv) a second tie layer, (v) a barrier layer, (vi) a third tie layer and (vii) an abrasion film layer, wherein the layer of polytetrafluoroethylene is disposed in contact with said material.

Another aspect of the invention relates to a material storage and dispensing package, comprising a vessel enclosing an interior volume and adapted for dispensing of material therefrom, a first liner disposed in the interior volume and arranged therein for holding a material to be dispensed from the package during such dispensing, and a second liner disposed in the interior volume and adapted to be inflated to exert pressure on the first liner to effect such dispensing of material from the package.

A further aspect of the invention relates to a method of supplying material, comprising use of such package.

Yet another aspect of the invention relates to a method of storage and dispensing of a material, comprising providing a vessel having an interior volume, disposing the material in a first liner in the interior volume, wherein the first liner is adapted for dispensing of the material from the vessel, providing a second liner in the vessel, and inflating the second liner to cause the second liner to compress the first liner so that the material in the first liner is dispensed from the vessel.

Other aspects, features and embodiments of the invention will be more fully apparent from the ensuing disclosure and appended claims.

### BRIEF DESCRIPTION OF THE DRAWINGS

FIG. 1 is a sectional elevation view of a liner-based fluid storage and dispensing package, according to one embodiment of the present invention.

FIG. 2 is a schematic perspective view of a fluid storage and dispensing package according to another embodiment of the invention.

FIG. 3 is a schematic perspective view of a fluid storage and dispensing package according to a further embodiment of the invention.

FIG. 4 is a schematic perspective view of a fluid storage and dispensing package according to yet another embodiment of the invention.

FIG. 5 is a schematic representation of a bag-in-bag liquid medium package according to another embodiment of the invention, in sectional elevation view.

FIG. 6 is a schematic representation of a liquid medium package according to a further embodiment of the invention, in sectional elevation view.

FIG. 7 is a schematic representation of a film laminate according to one aspect of the invention, in cross-section, showing the component layers of the laminate.

FIG. 8 is a schematic representation of a liquid medium-supplied manufacturing system, according to a further aspect of the invention.

FIG. 9 is a schematic representation of a material container, according to one embodiment of the invention

FIG. 10 is a schematic representation of the FIG. 9 container, upon filling thereof with liquid, and expansion of the balloon therein, to provide a zero headspace or near-zero headspace conformation.

FIGS. 11-20 illustrate the fabrication of a double liner-based container and the components and structures in the various assembly steps of the fabrication.

FIG. 21 is a schematic representation of a composite liner, according to another embodiment of the invention.

FIG. 22 is a schematic representation of a liner-based package, including a rigid outer container enclosing an interior volume within which it is disposed a liner suspended from the neck of the vessel, according to another embodiment of the invention.

FIG. 23 is a sectional elevation view of a multilayer laminate useful in the general practice of the present invention for construction of liners adapted for use in liner-based material containment packages.

FIG. 24 is a perspective view of a liner-based package of a bag-in-bottle type, according to another embodiment of the invention.

### DETAILED DESCRIPTION OF THE INVENTION, AND PREFERRED EMBODIMENTS THEREOF

The present invention relates to liner-based liquid containment systems for storage and dispensing of chemical reagents and compositions of widely varied character. Although the invention is hereafter described primarily with reference to storage and dispensing of liquid or liquid-containing compositions for use in the manufacture of microelectronic device products, it will be appreciated that the utility of the invention is not thus limited, but rather the invention extends to and encompasses a wide variety of other applications and contained materials.

Although the invention is discussed hereinafter with reference to specific embodiments including various liner-based packages and containers, it will be appreciated that various of such embodiments, e.g., as directed to pressure-dispense arrangements or other features of the invention, may be practiced in liner-less package and container systems.

The term “microelectronic device” as used herein refers to resist-coated semiconductor substrates, flat-panel displays, thin-film recording heads, microelectromechanical systems (MEMS), and other advanced microelectronic components. The microelectronic device may include patterned and/or blanketed silicon wafers, flat-panel display substrates or polymeric, e.g., fluoropolymer, substrates. Further, the microelectronic device may include mesoporous or microporous inorganic solids.

In liner packaging of liquids and liquid-containing compositions (hereafter referred to as liquid media), it is desirable to minimize the head space of the liquid medium in the liner. The head space is the volume of gas overlying the liquid medium in the liner.

The liner-based liquid media containment systems of the present invention have particular utility in application to liquid media used in the manufacture of microelectronic device products. Additionally, such systems have utility in numerous other applications, including medical and pharmaceutical products, building and construction materials, food products, etc., where liquid media or liquid materials require packaging.

As used herein, the term “zero head space” in reference to fluid in a liner means that the liner is totally filled with liquid medium, and that there is no volume of gas overlying liquid medium in the liner.

Correspondingly, the term “near zero head space” as used herein in reference to fluid in a liner means that the liner is substantially completely filled with liquid medium except for a very small volume of gas overlying liquid medium in the liner, e.g., the volume of gas is less than 5% of the total volume of fluid in the liner, preferably being less than 3% of the total volume of fluid, more preferably less than 2% of the total volume of fluid and most preferably, being less than 1% of the total volume of fluid (or, expressed another way, the volume of liquid in the liner is greater than 95% of the total volume of the liner, preferably being more than 97% of such total volume, more preferably more than 98% of such total volume, and most preferably more than 99% of such total volume).

The greater the volume of the head space, the greater the likelihood that the overlying gas will become entrained and/or solubilized in the liquid medium, since the liquid medium will be subjected to sloshing, splashing and translation in the liner, as well as impact of the liner against the rigid surrounding container during transportation of the package. This circumstance will in turn result in the formation of bubbles, microbubbles, and particulates in the liquid medium, which degrade the liquid medium, and render it potentially unsuitable for its intended purpose. For this reason, head space is desired to be minimized and preferably eliminated (i.e., in a zero or near-zero head space conformation) with complete filling of the interior volume of the liner with liquid medium.

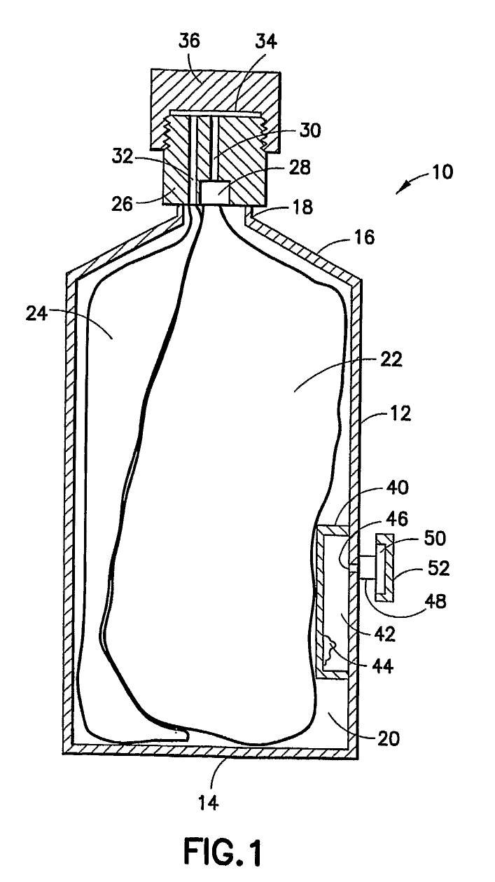

Referring now to the drawings, FIG. 1 is a sectional elevation view of a liner-based fluid storage and dispensing package 10, according to one embodiment of the present invention.

The fluid storage and dispensing package 10 of FIG. 1 includes a vessel with a cylindrical side wall 12, floor 14, tapered frustoconical shoulder 16, and cylindrical neck 18, enclosing interior volume 20. In the interior volume 20 is disposed a liner 22, filled with a liquid or liquid-containing composition (such liquid or liquid-containing composition hereafter being referred to as “liquid medium”).

The liquid medium can be of any suitable type, e.g., a semiconductor manufacturing liquid medium, such as photoresist, etchant, dopant, chemical vapor deposition reagent, solvent, wafer or tool cleaning formulation, chemical mechanical polishing composition, etc.

The interior volume 20 also has disposed therein a flexible inflatable bladder 24 that has been inflated with a suitable fluid medium, such as a gas or liquid. A preferred fluid medium is inert gas, such as helium, krypton, argon, etc., or a gas that is non-reactive in exposure to the materials in the interior volume 20, if such fluid medium were to permeate out of the bladder and enter the free space in the interior volume. The bladder can be of any suitable type. For example, it can be a non-rigid, or alternatively a semi-rigid, liner. In one specific embodiment, the bladder is constituted by a relatively rigid liner that is folded or rolled up, and unfolds or unrolls when inflated thereby exerting force to dispense liquid.

By filling the bladder 24 with a fluid medium of appropriate volume, the bladder is caused to bear on the liner 22, and to positionally retain the bladder in position in the interior volume 20. Such fixed positional retention of the liner 22 avoids the circumstance in which the liquid medium in the liner is subjected to impact against the interior surfaces of the vessel during transport, installation, etc., since the resulting forces on and translation of the liquid medium and liner may cause adverse effect on the liquid medium, e.g., resulting in particle generation in the liquid medium reducing its purity and suitability for its ultimate use.

Secured to the upper end of the neck 18 of the vessel is a cap 26, which may be leak-tightly secured to the vessel in any suitable manner, e.g., by welding, brazing, mechanical fastening, or any other means or method that is effective to secure the cap in position.

The cap as shown is provided with an interior passage 32 in fluid communication with the interior volume of the bladder 24. The cap also is provided with a cavity therein receiving a port 28 of the liner 22. The port is disposed in the cavity, so that the fluid medium in the liner 22 can be accessed through passage 30 in the cap. For this purpose, the port may be open to the passage 30, or the port may be provided with a closure, such as a membrane element or other seal, serving to keeping the liquid medium in the liner in an isolated state.

At its top surface, the cap 26 may be overlaid by a closure 34, such as a gasket or a seal. The closure may for example be adhesively secured to the cap top surface with a suitable low-tack adhesive, enabling peel-away removal of the closure when the vessel is deployed for use, and it is desired to access the liquid medium for dispensing from the liner in the vessel.

In the FIG. 1 arrangement, the cap 26 at its upper portion is threaded on its exterior side surface, to permit the cap to be threadably engaged with an overcap 36, which is complementarily threaded on an interior surface at its lower portion, as illustrated. The overcap may be employed to ensure sealing of the vessel contents, but may in some embodiments be omitted. Alternatively, the passages 30 and 32 in the cap 26 may each be individually sealed by a plug or other closure element (not shown in FIG. 1).

In the interior volume 20 of the vessel is a gas removal compartment 40, which may as illustrated be formed by an enclosure structure that is secured to the inner surface of the cylindrical side wall 12 of the vessel, to define an enclosed interior volume 42. The interior volume 42 of the compartment 40 is in restricted fluid penetration communication with the interior volume 20 of the vessel outside of compartment 40, i.e., fluid in the interior volume 20 of the vessel can penetrate into the interior volume 42 of the compartment, but such penetration is restricted by the walls of the compartment, or in other suitable manner.

For example, the walls of the compartment 40 may be formed of a material that is permeable to gas flux therethrough, so that when pressure in the interior volume 42 of the compartment 40 is below pressure in the interior volume 20 of the vessel outside of the compartment 40, the differential in pressure as well as concentration will mediate a flux of gas through the walls of the compartment.

Alternatively, the walls of the compartment 40 may be formed with openings therein having membranes across the openings, wherein the membranes are permeable to gas diffusion and permit gas to enter the enclosure.

As another alternative, the interior wall surface of the compartment 40 may have a getter 44 deposited thereon, wherein the getter is chemisorptive for atmospheric gases that may be present in the interior volume 20 of the vessel, such as oxygen, nitrogen, trace hydrocarbons, etc. The getter may be of any suitable composition, e.g., elemental barium, strontium, or other suitable material having chemisorptive reactivity with the gas species of interest that may be present in the interior volume of the vessel, and which if not removed, may diffuse through the liner into the liquid medium held therein.

As a still further alternative, the interior volume 42 of the compartment 40 may be evacuated. For such purpose, the wall of the vessel, e.g., side wall 12, may have an evacuation orifice 46 therein, for selective withdrawal of gas from the interior volume 42 of the enclosure 40. Orifice 46 in the illustrated arrangement communicates with a discharge port 48 having an interior passage therein (not shown in FIG. 1) and terminating in the coupling flange 50, by means of which the port may be connected with a vacuum pump, or other vacuum withdrawal apparatus, e.g., an eductor, ejector, turbine, fan, cryopump, or the like. The port 48 in the FIG. 1 drawing is shown as being capped at flange 50 of port 48 by closure cap 52. In such arrangement, the evacuation of the compartment 40 permits any extraneous gas present in the interior volume 20 of the vessel to permeate into the interior volume 42 of the compartment 40, whereby the pressure and presence of gas in the interior volume 20 outside of the compartment, may be minimized.

In another alternative arrangement, an evacuated space can also be provided in the container by providing a space between two liner layers that can be put under vacuum.

The arrangement shown in FIG. 1 provides a zero headspace conformation of the liner to be achieved, wherein the liquid can be filled to the port 28 of the liner, so that there is no void volume of air, vapor of the liquid, or other gas in the liner above the liquid. This is an important feature since the presence of any void volume of gas above the liquid in the liner has been found to produce bubbles, such as when pressure is exerted on the exterior surface of the liner during the dispensing operation, or alternatively during transport of the package after the liner has been filled, when any sloshing, splashing or the like that occurs incident to the transport or movement of the package produces gas-liquid interfacial area that effects solubilization and entrainment of the head space gas in the liquid.

This phenomenon (of sloshing, splashing of the liquid medium when there is a head space containing gas in the liner) has also been found to increase the production of particles in the liquid, which may for example take place as a result of particle shedding from the interior surface of the liner, or by coalescence or precipitation and agglomeration of suspended matter in the liquid, during the sloshing, splashing and other displacement of the liquid medium.

Such bubble and particle formation is severely detrimental in many instances, and is inconsistent with the high-purity desired for the liquid medium that will ultimately be dispensed from the liquid medium package. Further, any dissolved gases in the liquid medium will form bubbles if the pressure in the system is lowered, such as during the fill cycle of the pump that is used to effect introduction of liquid medium into the liner during the filling operation.

The provision of a zero headspace conformation of the liner, so that it is fully filled with liquid medium, assists in minimizing the bubble and particle formation problem discussed above, but it remains difficult to remove all bubbles from the package.

The FIG. 1 package addresses this residual bubbles problem. The liner 22 is filled with the liquid medium, and the bladder is expanded with a suitable pressurizing gas, to a pressure above the dispense pressure of the package. As an illustrative example, the liner may be subjected to a dispense pressure of 7 psig exerted on the exterior surface of the liner to effect compression of the liner and discharge of the liquid medium therefrom. In such embodiment, the bladder may be pressurized to a pressure of 10 psig, suitably above such dispense pressure level. During this pressurization, the liner package is vented, as is the interior volume 20 of the vessel, to accommodate the displacement of fluid from the liner as well as from the interior volume 20.

It will be appreciated that the liner and the bladder may each be provided with valves (not shown in FIG. 1) to isolate them from the atmosphere or other ambient environment of the package.

In a specific illustrative embodiment, the liquid medium is introduced into the liner to provide a zero head space conformation of the liner, and the filled package after expansion of the bladder with a suitable pressurizing gas is sealed. The package is thereafter maintained in a sealed state for an extended period of time, e.g., 30-45 days, before the package is opened and dispensing takes place. In the dispense operation, the package is coupled with a dispensing assembly including a dip tube connected to a dispense head, and pressure is exerted on the exterior surface of the liner, to dispense the liquid medium from the package. In such arrangement, after the package is filled and prior to the time the package is coupled to the dispense assembly, the pressure inside the zero head space liner will be at the pressure in the inflatable bladder and above the pressure in the interior volume 20 outside of the liner and the bladder. Such arrangement will cause any residual gas in the liner, e.g., trapped or solubilized in the liquid medium, to permeate through the liner to the interior volume 20 outside the liner during the storage, transport and other non-dispensing use of the package.

Further, such arrangement of the bladder and liner addresses the situation in which the fill operation is carried out with less than complete liquid medium fill of the liner, so as to accommodate thermal expansion and contraction of the fluid in the liner, without adverse effect. By providing a pressurized bladder having a pressure above the dispensing pressure of the fluid in the liner, head space gas overlying the liquid medium in the liner permeates out of the liner into the interior volume of the vessel exterior of the liner. In such fashion, the non-zero head space package tends to progress in subsequent pre-dispensing circumstances to a true zero head space package.

In order to prevent an over-pressure situation from developing in the interior volume 20 of the vessel, two paths can be used to relieve any such over-pressure. If the leak rate of the cap 26 to the ambient environment of the package is sufficient, then the excess gas pressure from the zero head space liner would leak out of the package to the ambient environment. If the package is alternatively very leak-tight, then an interior compartment such as compartment 40 can be employed, which is constructed and arranged for gas in-leak into the compartment to alleviate any overpressure condition in the exterior volume 20 outside the compartment.

As discussed above, the compartment can be under vacuum at the time that the package is sealed after fluid medium filling of the liner. The compartment provides an expansion volume to prevent pressure in the interior volume 20 of the vessel from rising as bubbles in the zero head space liner transpire into the interior volume 20.

It will be recognized that in lieu of a compartment secured to an interior wall surface of the vessel, it may be desirable in some instances to simply deploy a compartment article as a discrete, unattached article that is disposed in the interior volume of the vessel, or that is positionally retained in the vessel, in an appropriate manner. For example, the compartment article may comprise a capsule or a canister, e.g., with walls or other surface permeable to in-leaking gas, or valved for in-flow of gas when pressure in the interior volume of the vessel exceeds a set point of an inflow valve provided in such capsule or canister.

The bladder in the foregoing arrangement is appropriately made of a material that is highly impermeable material to prevent any leakage out of the bladder into the interior volume of the vessel. Since the bladder does not come into contact with the liquid medium contained in the liner, there are no compatibility issues in materials selection for the material of construction of the bladder.

The liner in the arrangement described in FIG. 1, in order to remove gases from the interior volume of the liner, must be made of a material having some, albeit small, permeability to the gas species that is desired to be removed. Potential materials of construction include, without limitation, polyethylene, polypropylene, polyvinylchloride, polyurethane, polyimide, polytetrafluoroethylene, and compatible copolymers of monomers thereof, and laminates including at least one layer of such polymers or copolymers. The liner can be formed by co-extrusion, solvent casting, or other appropriate technique.

The bladder may likewise be formed of any suitable material of construction that is flexible, resilient and expansible, in order for the bladder to be inflated to suitable pressure.

The bladder can be formed of any suitable elastomeric material, including natural rubbers, synthetic elastomers, memory metal foils, or the like. The pressurizing gas can be any suitable gas, and preferably is a gas that is not deleterious to the package or the liquid medium contained therein.

The bladder provides a mechanical pressurization of the zero head space liner, and therefore little or no gas diffusion occurs if pressure in the interior volume 20 of the vessel is not elevated.

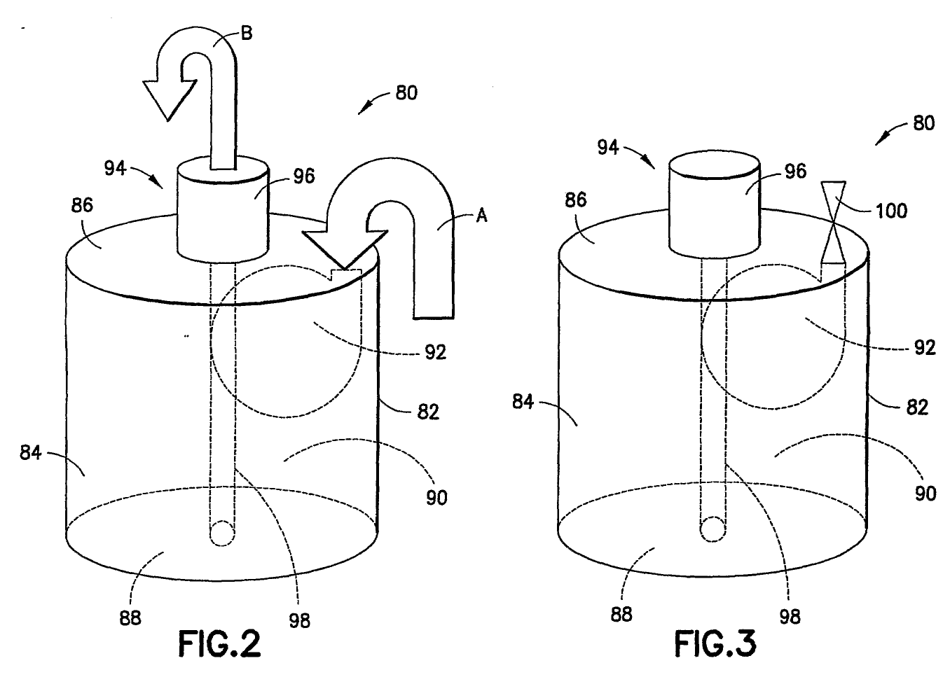

FIG. 2 is a schematic perspective view of a liquid storage and dispensing package according to another embodiment of the invention, which applies a head space to the vessel by a movable and/or flexible barrier without effecting deleterious gas-liquid interactions.

As discussed hereinabove, liquid media that are used in many applications are susceptible to degradation by factors related to head space gas interaction with the liquid medium that is package for storage, transport, and ultimately, dispensing of the liquid medium. Circumstances relating to such degradation include, without limitation, gas entrainment, formation of bubbles and microbubbles, particle generation, particle agglomeration, solvent evaporation, and concentration variations.

Currently, various liquid medium vessels are subject to regulations that require the provision of expansion space in the vessel, i.e., so that head space gas overlies the liquid.

The liquid storage and dispensing package 80 shown in FIG. 2 utilizes a flexible and movable barrier in the form of bladder 92 in the interior volume 90 of the vessel 82 of such package. The vessel 82 includes a cylindrical side wall 84, top end wall 86 and bottom end wall 88 enclosing such interior volume 90.

The interior volume 90 contains a liquid medium, which may for example include a microelectronic device manufacturing liquid medium, such as photoresist, etchant, chemical vapor deposition reagent, solvent, wafer or tool cleaning formulation, chemical mechanical polishing composition, etc. The vessel 82 is coupled with a dispensing assembly 94, which includes a dip tube 98 extending vertically downwardly into the interior volume of the vessel, and joined at its upper end to dispense head 96. The dispense assembly is coupled with the package 80 when it is desired to dispense the liquid medium from the vessel, or to ready the package for such future operation. The dip tube, while illustratively employed in the FIG. 2 embodiment, is not essential for the dispense operation, and the system may be alternatively configured without such dip tube, with pressure dispensing being carried out through a hole in the top of the container.

The dispense assembly 94 may be coupled in turn to suitable flow dispensing circuitry, indicated schematically in FIG. 2 by arrow B, whereby the liquid medium is conveyed to a locus of use, such as a liquid medium-utilizing apparatus.

To apply head space to the liquid medium in the vessel 82 without deleterious contacting of the liquid medium, the apparatus shown in FIG. 2 uses a flexible and/or movable barrier that is used to apply pressure to the body of liquid medium in the vessel, so that it is dispensed from the vessel under the action of such pressure. The flexible and/or movable barrier in the FIG. 2 system is bladder 92, which is coupled to an inflation assembly schematically indicated by arrow A in the drawing.

The inflation assembly can be any source of pressurizing fluid that is introduced into the interior volume of the bladder 92 for expansion thereof, to confine the liquid, e.g., to provide zero head space during transport and storage of the package, and upon installation for dispensing of liquid medium from the vessel, the bladder 92 may be coupled to an inflation assembly to further expand the bladder, to effect pressure dispensing of the liquid medium through the dispensing assembly to the flow circuitry schematically indicated by arrow B.

The bladder may for the purpose of pressurization be accompanied by an inflation assembly that is on-board the liquid medium package, or provided as a separate module associated with the package. The bladder may be formed of any suitable material of construction, such as natural rubbers, synthetic elastomers, natural/synthetic elastomer blends, etc., and may be pressurized with any suitable pressurizing gas, such as air, nitrogen, helium, carbon dioxide, etc.

The bladder in the FIG. 2 embodiment could alternatively be replaced by other barrier structure, such as for example a disc-shaped barrier that has a central opening therein, to accommodate passage of the dip tube therethrough, wherein the disc-shaped barrier is aligned in the interior volume of the vessel with its main top and bottom surfaces parallel to the top end wall 86 and the bottom end wall 88 of the vessel. The barrier in such arrangement is adapted to translate vertically up and down in the interior volume 90, with the outer edge of such barrier in fluid-tight contact with the interior surface of the cylindrical side wall 84, and the central opening of the barrier being in fluid-tight contact with the dip tube, so that movement of the barrier does not mix the liquid medium and the pressurizing gas. The pressurizing gas thereby is introduced to the vessel 82 to exert pressure on the top face of the barrier, thereby transmitting such pressure to the liquid, to effect pressure dispensing of the liquid medium through the dip tube 98 and the dispense head 96 as previously described.

Such arrangement of the flexible and/or movable barrier can be applied to any vessel, fluid package, etc., including bottles, bags, boxes, bag-in-box containers, canisters, and the like. The barrier allows for expansion space in the vessel, where required by applicable regulations, while keeping the liquid medium separate from the pressurizing fluid.

Although described with reference to the use of a pressurizing gas as the pressurizing fluid for the bladder in the embodiment of FIG. 2, it will be appreciated that liquid may be used as the pressurizing fluid for effecting pressure dispensing of the liquid medium in FIG. 2.

It will likewise be appreciated that although the embodiment of FIG. 2 has been described with reference to a liquid medium being the material dispensed in such embodiment, gas or vapor may alternatively be the medium contained in the vessel 82 and dispensed therefrom under the impetus of the expanded bladder being filled with fluid.

FIG. 3 is a schematic perspective view of a fluid storage and dispensing package according to a further embodiment of the invention, wherein all parts and features are numbered correspondingly with respect to the same parts and features in the embodiment shown and described with reference to FIG. 2.

The FIG. 3 embodiment differs from that shown in FIG. 2, in the provision of a plug 100 captivating the fluid inside the bladder 92, so that the fluid in the interior volume of the vessel 82 can expand or contract due to temperature variation, chemical reactions, etc., with the fluid in the bladder 92 in turn being correspondingly contracted or expanded during to variation in pressure in such fluid.

The fluid in the bladder may be any suitable liquid or gaseous medium, and the fluid in the interior volume 90 of the vessel 82 may likewise be any suitable liquid or gaseous medium. The fluids in the bladder 92 and in the interior volume 90 of the vessel 82 are thereby in dynamic equilibrium with one another, to accommodate variations in conditions of the fluids and the environmental conditions of the vessel, such as ambient temperature, etc.

The plug 100 may be provided in the form of a valve, openable port or the like, to accommodate coupling thereto of a fluid source, for addition of fluid to the interior volume of the bladder 92, for pressure dispensing of the fluid in the interior volume 90 of the vessel 82, or the plug may comprise a pressure relief valve which can accommodate overpressure conditions developing in the vessel 82 by releasing fluid from the bladder 92, whereby the fluid in the vessel can expand to relieve overpressure increases that would otherwise compromise the safety or structural integrity of the fluid package 80.

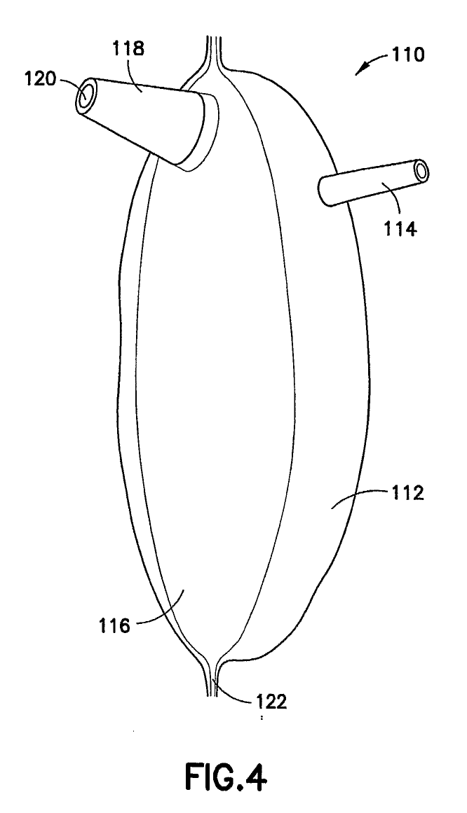

FIG. 4 is a schematic perspective view of a fluid storage and dispensing package according to yet another embodiment of the invention.

The package 110 of FIG. 4 is a composite package structure including an outer bag 112 that is circumscribingly arranged about the periphery of an inner bag 116. The inner and outer bags in the embodiment shown are formed of sheet film stock, and are welded at edges of the sheets so that each bag encloses an interior volume, and is inflatable or fillable with liquid medium, or other fluid or solid material, or material in some other form. There is a space between the respective bags that is pressurizable. The inner bag 116 as shown is provided with a fitment 118 thereon, which includes an end opening 120, to allow ingress and egress of material to and from the interior volume of the inner bag. The fitment opening 120 may be closed with a suitable closure member, e.g., a cap or other closure article or material.

The bag assembly has a weld area 122 representing the juncture of four films used in the illustrated composite package article.

In the illustrated embodiment of FIG. 4, the outer bag 112 is provided with a pressurization air inlet 114 that communicates with the space between the respective bags 112 and 116. In this manner, air or other pressurizing gas can be introduced through the pressurization air inlet to pressurize the space between the bags, e.g., so that pressure can be exerted on the inner bag to assist in dispensing liquid medium or other fluid material under the applied pressure thereon.

Thus, the inner bag 116 can be filled with a liquid medium or other material, and subsequent to such filling, pressurizing gas can be introduced to the pressurization inlet 114 to expand the outer bag, and place it in compressive bearing relationship to the inner bag, so as to positionally fix the overall article, and rigidify same.

The inflation passage in pressurization air inlet 114 may contain a self-closing valve, or the air inlet may be cappable or other closable with a closure of appropriate form.

At the point of use of the material contained in the inner bag, the pressurization air inlet may be coupled with a source of pressurized air or other pressurizing gas, and the space between the respective bags may be further pressurized to expand the outer bag and increase the pressure exerted on the bag for effecting pressure discharge of the contained material from the inner bag.

The inner and outer bags may be constructed in any other suitable manner, to provide selectively inflatable or expansible compartments or volumes that cooperate to enable filling of one or more compartment(s) with a fluid medium or other material, and the other or others of the compartment(s) to be pressurized to rigidify the overall article for storage, transport, etc., and with the compartment(s) being able to be further pressurized at the point of use to achieve pressure-assisted dispensing of the contained fluid or other material from the storage compartment(s).

Such multi-volume article provides a convenient and effective storage and dispensing article for high-purity and ultra-high purity liquid media, such as chemical reagents used in the manufacture of microelectronic device devices and products.

The respective compartments of the multi-compartment storage and dispensing article can be formed of any suitable materials of construction, e.g., natural and synthetic rubbers, non-rubber elastomers, polymeric elastomeric blends, expansible memory metal films, etc.

In the FIG. 4 package, the liquid to be dispensed can be contained (i) in the inner liner, (ii) between the inner and outer liners, or (iii) in the case of a four-weld liner, in one of the outer compartments between the liner.

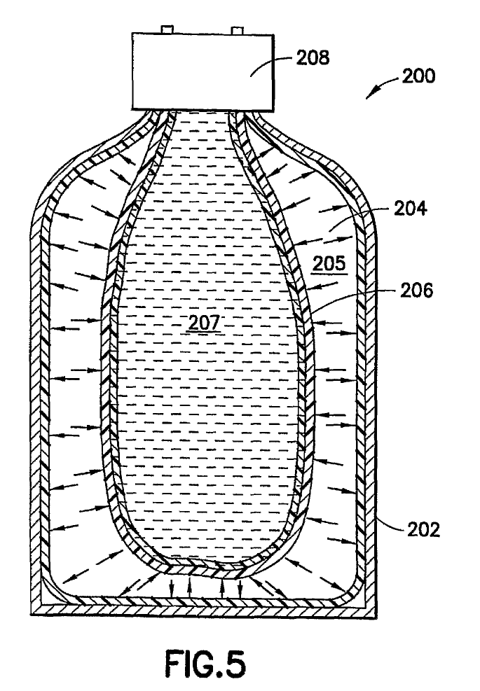

FIG. 5 is a schematic representation of a bag-in-bag liquid medium package 200 according to another embodiment of the invention, in sectional elevation view. The package 200 includes a vessel 202 which may for example be formed of a polymeric, metal or other suitable material of construction, forming an overpack structure, within which is disposed a first bag 204 enclosing interior volume 205. The first bag 204 surrounds the interiorly positioned second bag 206 enclosing interior volume 207. The second bag 206 in its interior volume 207 contains liquid medium such as a chemical reagent, in a zero head space conformation of the liner defined by the second bag.

The first bag 204 surrounding the second bag is filled in its interior volume 205 with an inflation gas, such as air, nitrogen, argon, etc. The vessel 202 is capped with a cap 208, which may be configured with port or coupling elements, for joining of the package to suitable dispense apparatus, as well as a gas source of inflation gas, so that the first bag 204 can be inflated to a desired extent, to effect pressure dispensing of liquid medium from the second bag 206.

The first bag 204 by such arrangement circumscribes the second bag and exerts compressive force thereon. The magnitude of the compressive force is dependent on the level of inflation pressure in the first bag 204, and such pressure can be modulated to progressively increase and thereby expand the first bag, so that liquid medium is compressively squeezed from the second inner bag 206 under the progressively increasing pressure exerted thereon.

In this manner, the liquid medium is dispensed from the package to an external point of use.

The FIG. 5 embodiment thus illustrates the use of an annularly circumscribing bat that serves in essence as a pressure cuff on the inner bag to effect the pressure dispensing operation.

It will be appreciated that the package of FIG. 5 may be arranged and operated so that it is the inner bag 206 that is pressurized with inflation gas to expand the bag and exert pressure compressively against the outer bag. In such arrangement, then the outer bag would contain the liquid medium, which would be dispensed from the outer bag through flow passage structure in the cap and to the external locus of use.

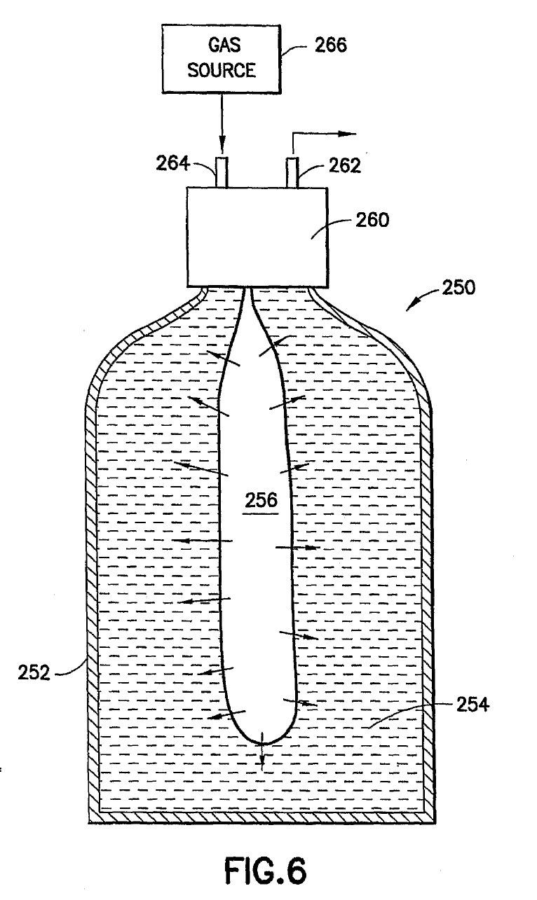

FIG. 6 is a schematic representation of a liquid medium package 250 according to a further embodiment of the invention, in sectional elevation view, which also utilizes a central bag 256 in a container 252, but without the outer bag as shown in the embodiment of FIG. 5. In the FIG. 6 arrangement, the central bag is an inflation gas-filled bag in operation of the package for dispensing. The bag 256 is surrounded by liquid medium 254 in the container 252, and as the bag 256 is expanded by the inflation gas introduced thereinto in gas feed line 264 from gas source 266, the bag exerts pressure on the liquid medium surrounding it. The liquid medium, as an incompressible medium, responsively is dispensed from the container in discharge line 262 in the cap 260.

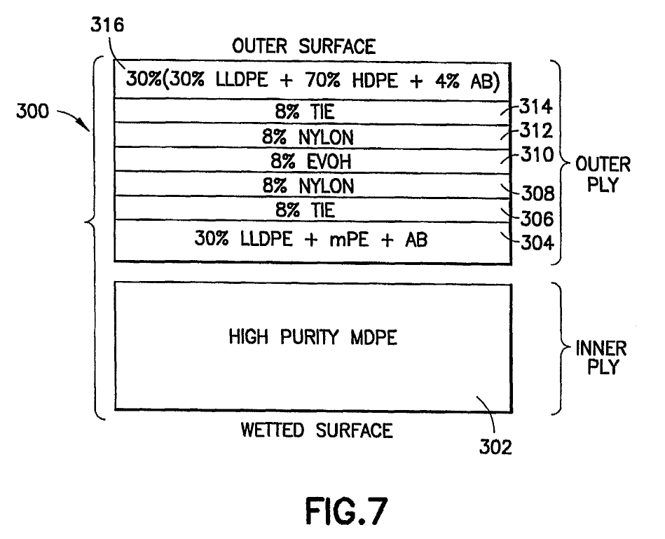

FIG. 7 is a schematic representation of a film laminate 300 according to one aspect of the invention, in cross-section, showing the component layers of the laminate. The laminate is of a construction that is advantageous for containment of liquid medium, as a material of construction for liners for use in connection with liquid medium packages. The laminate thus may be advantageously used in connection with liquid medium storage and dispensing packages, including those disclosed herein, and is advantageous in application to zero head space liners, due to its low permeability and high strength characteristics.

The laminate 300 as shown is a two-ply laminate including an inner ply of high purity medium density polyethylene (MDPE), and an outer ply including the seven component layers 304-316 that are co-extruded by a process in which the seven extruded component layers are passed through a die and then processed as blown film, slit and consolidated as sheet film stock with the inner ply high purity MDPE layer. Such co-extrusion and film processing operations per se are of a conventional character known to those skilled in the art of polymer processing, but such operations have not been heretofore to form a laminate of the type illustratively shown in FIG. 7.

The laminate of FIG. 7 provides unexpectedly superior liner performance when used to fabricate liners for use in liner-based liquid medium pressure-dispense packages. The outer surface layer provides excellent “slip” characteristics so that a liner formed of such film is able to move against an adjacent structure in contact with such surface, without undue wrinkling, binding or surface hold-up that would otherwise increase the susceptibility of the liner and liquid therein to particle and microbubble formation. Such laminate additionally has superior flexural character, strength and deformation properties that render it suitable for use in liners of even very large size. Further, the laminate has superior permeability resistance to gases that might otherwise pass though the liner film and enter the liner interior volume to degrade the zero head space character when the liner is deployed in a zero head space conformation.

The laminate 300 in the outer ply includes a first inner layer 304 formed of linear low density polyethylene (LLDPE) blended with medium density polyethylene (mPE) and formulated with an anti-block agent. This layer is provided at a thickness that is 30% of the overall thickness of the outer ply. The outer ply includes, progressing outwardly from the inner layer 304, a tie layer 306 at a thickness that is 8% of the total thickness of the outer ply, a nylon layer 308 that is 8% of the total thickness of the outer ply, an ethylene vinyl alcohol (EVOH) layer 310 that is 8% of the total thickness of the outer ply, a nylon layer 312 that is 8% of the total thickness of the outer ply, a tie layer 314 at a thickness that is 8% of the total thickness of the outer ply, and an outer layer 316 that is formed of 30% wt. linear low density polyethylene (LLDPE) blended with 70% wt. high density polyethylene (HDPE) and formulated with 4% wt. of an anti-block agent. Outer layer 316 constitutes 30% of the total thickness of the outer ply.

The layers in the laminate may have any suitable thicknesses consistent with the specific end use of the laminate.

In the laminate, the nylon layers 308 and 312 do not require bonding to the EVOH layer, since such layers naturally adhere to one another. The nylon layers 308 and 312 nonetheless must be bonded to the outer polyethylene layers 304 and 316, and the tie layers 306 and 314 are utilized for such purpose. The tie layers 306 and 314 are formed of anhydride-modified high density polyethylene or of anhydride-modified linear low density polyethylene, and such modified polyethylenes are highly effective in bonding the nylon and the polyethylene layers to one another. Suitable modified polyethylenes of such type are commercially available from E.I. du Pont de Nemours and Company (Wilmington, Del.) as Series 4000, Series 4100 and Series 4200 anhydride-modified polyethylenes.

The overall thickness of the laminate 300 may be of any suitable thickness, as necessary or desirable in a given application of the laminate. In application to liners for liquid media, the thickness of the outer ply may for example be on the order of 2-4 mils, and the overall thickness of the laminate, including the inner ply of high purity medium density polyethylene, may be 5-6 mils.

The anti-block agent used in the inner layer 304 and outer layer 316 of the outer ply can be of any suitable type. An illustrative anti-block agent that has been used to advantage in fabricating films for the foregoing laminate is diatomaceous earth.

Such laminate may be utilized in sheet form to fabricate a liner, e.g., by superposition of corresponding sheets, and welding of same at their edges to form edge seams of a leak-tight character, such as by ultrasonic welding or other suitable film processing technique.

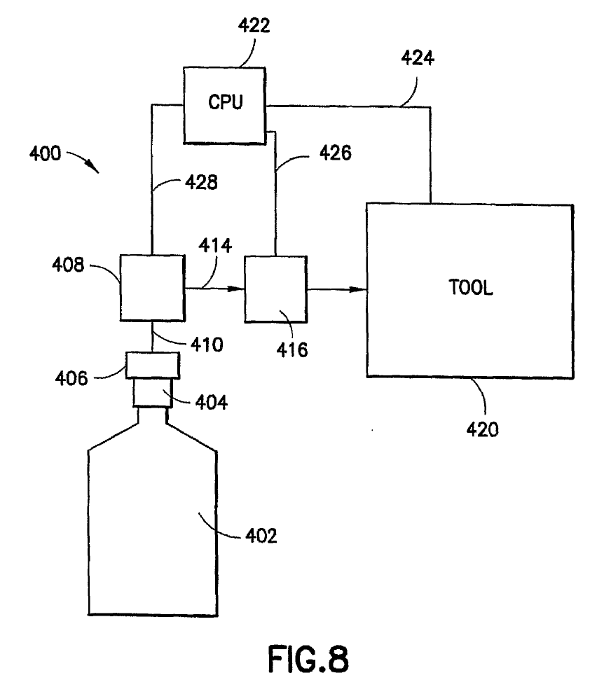

FIG. 8 is a schematic representation of a liquid medium-supplied manufacturing system 400, according to a further aspect of the invention.

The FIG. 8 system 400 includes a container 402 holding liquid medium. The container 402 may be a liner-based container, including a liner holding the liquid medium in a rigid overpack or vessel, or the container may alternatively be a liner-less container, in which the liquid is held in the vessel, in contact with the vessel interior surfaces.

The container 402 is capped with a cap 404 that in the embodiment shown mates with a dispense head 406 and may include a dip tube for immersion in the liquid, or the container alternatively can be arranged for dispensing in some other manner. The container may be equipped with passage or coupling structure for connection to a gas source for pressure-mediated dispensing of liquid medium from the container. The dispense head 406 is connected to a dispense line 410 that may flow to a valve assembly 408 including an actuator that is selectively actuatable to initiate the liquid dispensing operation.

From the valve assembly 408, the liquid medium is flowed in discharge line 414 optionally having flow monitoring and control devices, represented schematically at 416, therein. The flow monitoring and control devices can be of any suitable type or types, and may for example include mass flow controllers, temperature sensors, pressure transducers, flow rate monitors, impurity detectors, component analyzers, restricted flow orifices, fluid pressure regulators, etc. From the fluid medium discharge line 414, the fluid medium is flowed into the fluid medium-utilizing tool 420.

The tool can be of any suitable type, e.g., a microelectronic device manufacturing tool, such as a photoresist application tool, chemical vapor deposition chamber, ion implantation unit, etching chamber, plasma generator, or other apparatus appropriate to the manufacturing tool.

The manufacturing system 400 can optionally be equipped with automatic control subsystems, for controlling the liquid dispensing and tool operation process. Accordingly, the system can employ a CPU 422, which is linked by signal transmission lines to the system components, including signal transmission line 428 to valve assembly 408, signal transmission line 426 to flow monitoring and control devices 416, and signal transmission line 424 to the tool 420. The signal transmission lines may be constructed and arranged to transmit sensed or generated signals from the system components to the CPU 422, and/or to send control signals from the CPU 422 to the controlled components of the system. The CPU can be of any suitable type, e.g., a microcontroller, programmable logic controller, microprocessor, CPU of a programmable general purpose computer, etc.

The manufacturing system illustratively shown in FIG. 8 can utilize any of the various liquid medium packages and dispensing systems described herein, or in the related applications co-filed herewith and identified hereinabove, for the manufacture of products of the process carried out in the manufacturing system using the dispensed liquid medium.

The zero head space conformation for the filling, storage, transport, and installation of packages containing high purity liquid media (e.g., >99.9995% pure) is highly desirable in the suppression of bubble and particle effects, such as the formation and agglomeration of particles in the high purity liquid medium, and formation of bubbles and microbubbles upon decompression of the liquid.

The invention in another aspect accommodates the need for an expansion volume to be provided for the liquid medium in the container in a zero head space conformation, so that the liquid medium does not overflow if the liquid medium is at elevated temperature, by a liquid medium container that has a semi-flexible portion that is extensible or deformable from an expanded or normal shape of the container, to provide a compacted volume for the liquid in which the liquid is in a zero head space conformation, or a near-zero or lowered head space conformation, for shipping, transport and installation, but in which the semi-flexible portion of the container is expansible or extendible at the point that the package is opened for dispensing or access to the liquid medium.

For example, activation of the semi-flexible portion of the container may be effected by mechanical technique, such as squeezing the container, to compact it so that the liquid is in the desired low or no head space conformation. Alternatively, the package could be subject to vacuum or a pressure differential to cause extraction of the head space gas to collapse or flex the semi-flexible portion of the container so that a low or no head space conformation is achieved. After eliminating the head space, the container is capped or otherwise maintained in the low or no head space conformation. This results in a slightly reduced pressure in the container. The semi-flexible portion of the container must be constructed so that the absolute pressure in the container does not approach the vapor pressure of the liquid medium being contained. Typically, this means that the semi-flexible portion of the container should not reduce the pressure inside the container by more than 5 psi (0.35 kg/cm²).

A top, bottom or side wall or panel of the container may constitute the semi-flexible portion of the container, or some other portion of the container could include or function as such portion. The semi-flexible portion could also be incorporated into the structure of the container in any suitable manner, to effect the compaction or deformation that is productive of the desired low or no head space conformation of the container in respect of the liquid medium therein.

It will be appreciated that a zero or other low head space conformation of the container may be provided in the first instance, with a semi-flexible portion of the container being extensible or otherwise expandible from a normal compact shape of the container, to provide an expansion volume for the liquid at the time that the package is opened for dispensing or access to the liquid medium. This is the inverse situation to that discussed hereinabove, where the container is normally in an expanded state, but is compacted to a low profile or smaller conformation to accommodate the low or no head space conformation. For example, the container may have a pull-out extension, such as an expandable bellows or a fold-out passage member that increases the interior volume available to the liquid medium in the container.

Accordingly, such approach of the invention is readily applied by the provision of a container that is shape-shiftable to vary the interior volume available to the liquid medium in the container, whereby the interior volume is selectively variable between an expanded volumetric state providing a greater head space and a compacted volumetric state providing a smaller head space.

The invention in a further aspect relates to minimal head space systems for high purity (e.g., >99.9995% pure) liquid media, in which the head space overlying the liquid medium in a liner or other container is selected to (i) provide sufficient space to accommodate expansion/contraction effects, and (ii) avoid production of a saturated pressure equal to or greater than 3 psig (0.21 kg/cm²) in the head space, so that the liquid medium does not saturate to a pressure of 3 psig or greater when mixed and dispensed.

The first criterion is necessitated by regulatory constraints that impose a requirement of an expansion volume in the liquid container, and the second criterion is based on the fact that saturation pressures of 3 psig (0.21 kg/cm²) or higher have been found to lead to bubble formation upon decompression of the liquid, e.g., at the point of dispensing of the high purity liquid medium from the liner or other container. The objective achieved by the second criterion is keeping the volume of gas low enough so that even if all gas were to go into solution during mixing and dispensing, the equilibrium vapor pressure in the solution would remain below 3 psig.

The foregoing therefore provides a criterion that permits a head space volume to be determined for a given high-purity liquid medium, that will ensure the appropriate performance of the liquid, such as in the case of microelectronic device manufacturing reagents that must be free of bubbles, microbubbles and particulates, in order to be suitable for use in microelectronic device manufacturing processes.

The foregoing criterion and its determination in specific applications to provide a minimum head space for liquid medium in a liner or other package is illustrated by the following non-limiting example.

### EXAMPLE

Propylene glycol methyl ether acetate (PGMEA) is a common reagent employed extensively in microelectronic device manufacturing operations. For a four-liter volume of PGMEA, it was verified that if the saturated pressure, Pₛₐₜ, of the solution is below 3 psig (0.21 kg/cm²), dissolved gases will not form an appreciable amount of bubbles upon decompression. Four liters of PGMEA were filled into the liner of a NOWPAK liner package (commercially available from ATMI, Inc., Danbury, Conn., USA) and saturated pressures were determined as a function of head space volume, from which it was found that if the head space volume was increased from a substantially zero head space condition to about 10 milliliters of head space, the saturation pressure of the liquid is maintained below 3 psig, and bubble formation did not occur to any significant extent during decompression of the liquid.

The present invention as indicated relates generally to material containment systems for storage, transport and dispensing of a wide variety of materials. In various embodiments and aspects, the invention relates to liners for use in material containment packages, and to packages including such liners. Still further, the invention relates to multilayer film laminates, other type useful for manufacture of liners for use in liner-based material packages.

Although the ensuing discussion of the present invention is primarily directed to liner-based material containment packages utilized for storage and dispensing of liquid materials, it will be recognized that the liner-based packages of the invention are not thus limited to liquid materials in utility, but rather are useful for storage and containment of a wide variety of materials, including solids, solid-liquid suspensions, liquid- and/or gas-containing materials, etc.

The materials that may be contained in liners in liner-based packages of the present invention include, without limitation, semiconductor manufacturing reagents, pharmaceutical compositions, high purity industrial solvents, food products, beverages, forensic samples, water quality samples, fuels, blood and plasma products, and plant nutrient solutions, to name but a few. In one preferred aspect, the material comprises a liquid or liquid-containing composition used in manufacturing of microelectronic device products, such as photoresist, etchant, dopant, chemical vapor deposition reagent, solvent, wafer or tool cleaning formulation, chemical mechanical planarization composition, etc.

The term “microelectronic device” as used herein refers to resist-coated semiconductor substrates, flat-panel displays, thin-film recording heads, microelectromechanical systems (MEMS), and other advanced microelectronic components. The microelectronic device may include patterned and/or blanketed silicon wafers, flat-panel display substrates or polymeric, e.g., fluoropolymer, substrates. Further, the microelectronic device may include mesoporous or microporous inorganic solids.

As used herein, the term “zero head space” in reference to fluid in a liner means that the liner is totally filled with liquid medium, and that there is no volume of gas overlying liquid medium in the liner.

Correspondingly, the term “near zero head space” as used herein in reference to fluid in a liner means that the liner is substantially completely filled with liquid medium except for a very small volume of gas overlying liquid medium in the liner, e.g., the volume of gas is less than 5% of the total volume of fluid in the liner, preferably being less than 3% of the total volume of fluid, more preferably less than 2% of the total volume of fluid and most preferably, being less than 1% of the total volume of fluid (or, expressed another way, the volume of liquid in the liner is greater than 95% of the total volume of the liner, preferably being more than 97% of such total volume, more preferably more than 98% of such total volume, and most preferably more than 99% of such total volume).

The greater the volume of the head space, the greater the likelihood that the overlying gas will become entrained and/or solubilized in the liquid medium, since the liquid medium will be subjected to sloshing, splashing and translation in the liner, as well as impact of the liner against the rigid surrounding container during transportation of the package. This circumstance will in turn result in the formation of bubbles, microbubbles, and particulates in the liquid medium, which degrade the liquid medium, and render it potentially unsuitable for its intended purpose. For this reason, head space is desired to be minimized and preferably eliminated (i.e., in a zero or near-zero head space conformation) with complete filling of the interior volume of the liner with liquid medium.

In one aspect, the present invention relates generally to a material containment package in which material potentially susceptible to bubble formation therein is contained, having a headspace associated therewith, in which the headspace is placed under vacuum. Under these conditions, bubbles do not persist in the material because they are collapsed by the hydrostatic pressure of the material, e.g., liquid or liquid-containing material. The vacuum pressure in the headspace is reduced to the vapor pressure of the most volatile species in the contained material, and dissolved gases are removed during the filling operation prior to the sealing of the containment package. The containment package in such sealed state must be able to accommodate the mechanical forces associated with the vacuum, without collapsing or sustaining adverse effect on its structural integrity.

The containment package desirably is substantially impermeable to atmospheric gases or other gas species in the ambient environment of the containment package, to avoid circumstances in which the pressure outside the containment package changes to such an extent that it causes formation of bubbles in the contained material.

In instances in which the containment package includes a liner disposed in a container, the permeation barrier can be constituted at least in part by the liner.

In another aspect of the invention, a material containment package is provided, including a vessel having a port therein. A balloon is inserted into the vessel and inflated, whereby fluid is displaced from the interior volume of the vessel through the port, following which the port is closed and the interior volume of the vessel contains the inflated balloon. In such configuration, the balloon serves as a pressure equilibration component of the package, to accommodate internal pressure changes due to expansion and contraction of the contained material, e.g., liquid.

As applied to a liquid containment system, this arrangement is characterized by the absence of a gas/liquid interface (since the gas in the interior volume of the container is displaced through the port by the inflation of the balloon to an extent ensuring complete expulsion of gas from the interior volume of the container). Since there is no gas/liquid interface, the formation and entrainment of bubbles in the liquid is avoided.

In one embodiment of the above-described liquid containment system, mobility of the inflated balloon in the container is constrained by use of an open cell foam material introduced into the balloon as an inflation/expansion medium that is used to positionally fix and solidify the balloon after the headspace gas in the container is eliminated from the interior volume.

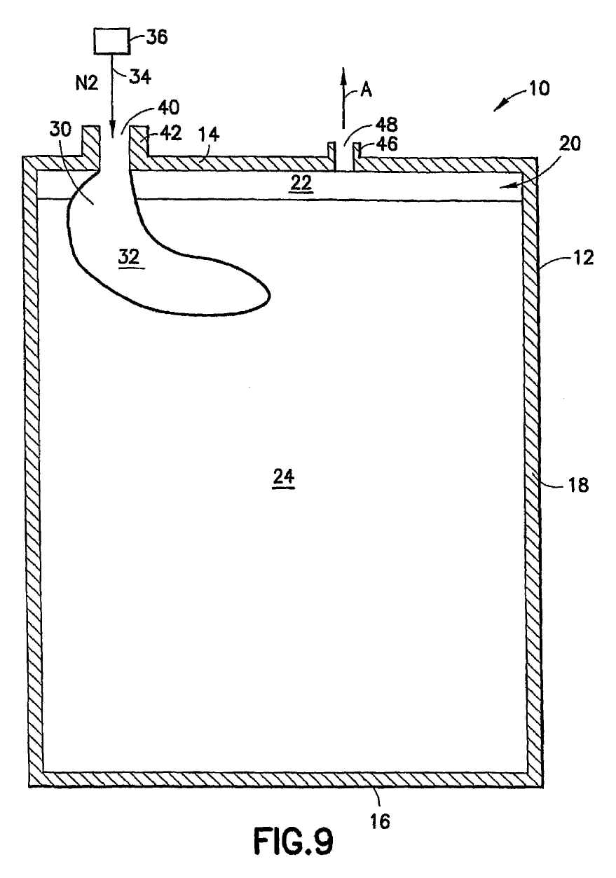

FIG. 9 is a schematic representation of a material container, according to one embodiment of the invention

As illustrated, the material container 10 includes a vessel 12 having a top wall 14, floor 16 and circumscribing sidewall 18, which together enclose an interior volume 20 of the container. The container on its top wall 14 includes a port 42, defining a port opening 40, and a port 46, defining a port opening 48.

The vessel 12 is shown as containing liquid 24, which has been introduced to the interior volume 20, through port 42 or 46, in a prior filling operation. The liquid 24 is overlaid by a headspace 22, containing air or other gas.

Disposed in the interior volume 20, as secured to the port 42, is an inflatable balloon 30 defining an enclosed volume 32 therein. Coupled with the port, by means of a feed line 34, is a source 36 of inflation gas, such as nitrogen. The inflation gas is flowed from the source 36 in feed line 34 into the enclosed volume 32 of the balloon 30, for installation of the balloon. As the balloon is inflated, it displaces gas from headspace 22 through the opening 48 of port 46, in the direction indicated by arrow A.

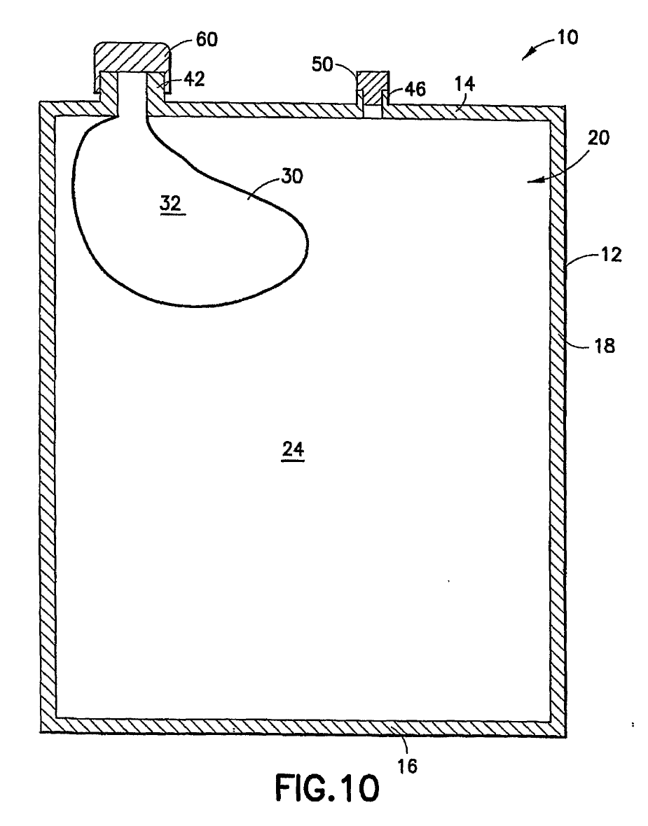

The inflation operation is continued until the balloon 30 is inflated as shown in FIG. 10, to completely expel the headspace gas from the vessel, whereupon the port 46 is plugged by plug 50 and the port 42 is closed by cap 60. The vessel then is in a zero headspace state (no gas overlying the liquid), or a near-zero headspace state, with the balloon 30 containing the inflation gas in the enclosed volume 32, whereby expansion or contraction of the liquid as a result of temperature or other ambient variation will correspondingly compress or expand the balloon, so that stress on the interior walls of the vessel by the liquid is avoided.

The cap 60 and the plug 50 may be complementarily threaded to mate with cooperative threading on the outside surfaces of the ports 42 and 46, respectively. Alternatively, the cap 60 and plug 50 may be lockingly coupled to the respective ports in any other suitable manner, to provide leak-tight closure of the respective port openings.

In another embodiment, in lieu of the use of an inflation gas, the balloon may be expanded by injection of a non-gaseous medium, such as a solid, semi-solid, gel, or other medium into the enclosed volume 32 of the balloon. Such introduced material may be cured, e.g., by cross-linking, thermosetting, or other cure modality, to establish an enlarged volume that is positionally fixed in the interior volume 20 of the vessel, yet is able to accommodate changes in pressure of the contained liquid in the vessel without adverse effect.

In another embodiment, the container 10 shown in FIG. 9 may be constituted without the balloon 30, and with vacuum pressure exerted on the headspace 22 by a vacuum pump, for extraction of a headspace gas in the direction indicated by arrow A, while port opening 40 is capped by a suitable closure. By such arrangement, the liquid 24 in the vessel 12 can be placed under vacuum conditions for storage and transport of the liquid.

Another aspect of the invention relates to a multi-layer liner for use in a liner-based package for containment of material. In the multilayer liner, a highly gas-permeable inner layer is attached to a low gas-permeable outer layer. The inner and outer layers may be made of any suitable materials that have the specified permeability characteristics and are otherwise suitable for containment of the material to be stored in and dispensed from the liner-based package. For example, the inner layer may be formed of a polytetrafluoroethylene film, and the outer liner may be formed of polyethylene.

A special fitment is required for introduction of a suitable gas into the space between the respective liners, as hereinafter described in greater detail. Such arrangement allows a specific gas or other suitable chemistry to be introduced into the inter-liner space, which is beneficial to the contained material. The beneficial chemistry therefore may include a gas that serves to extend the shelf life of a chemical composition stored in the inner liner, a ripening gas for unripe fruit stored in the inner liner, or other gaseous medium or chemistry that desirably diffuses through the inner liner into the interior volume of the inner liner, to benefit the material held in such inner liner.

At the point of use, any residual gas in the inter-liner volume and the evacuated from such volume prior to dispensing operation, so that the respective inner and outer liners are in contact with one another. At that point, drive gas can be introduced into the container, into the space between the outer liner and the interior walls of the container, to effect pressure-dispensing of material from the inner liner. The drive gas between the outer liner and the interior walls of the container therefore progressively collapses and compacts the liner assembly, to force the contained material therefrom, in the dispensing operation.

In another embodiment, the inter-liner space can be filled with a gas that is of low permeability in respect of either film bounding such space. In such embodiment, the introduced gas is placed into the space between the inner and outer liners, in order to provide a “barrier gas layer” therebetween.

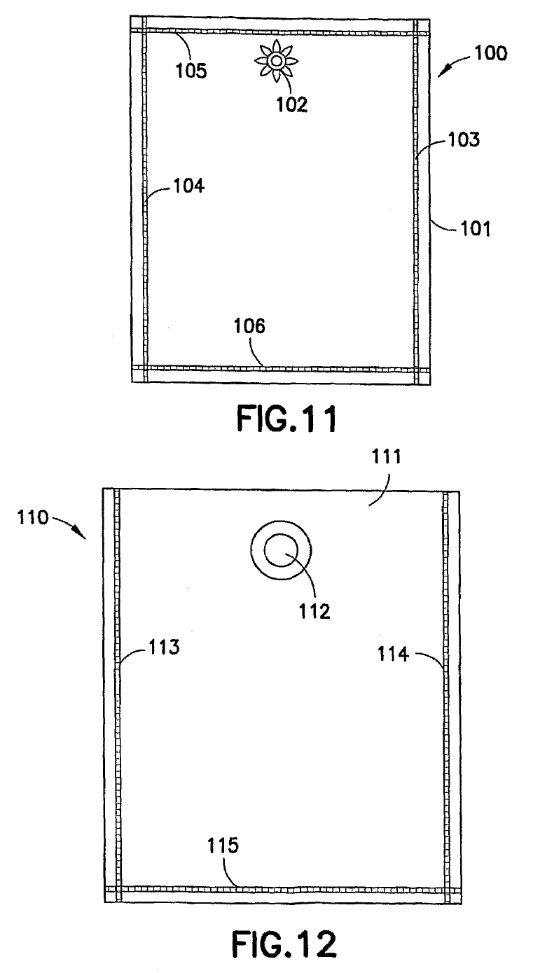

FIGS. 11-20 illustrate the fabrication of such double liner-based container and the components and structures in the various assembly steps of the fabrication.

FIG. 11 is a front elevation view of the inner liner 100, comprising an assembly 101 of two superposed sheets of polymeric film that are in register with one another with respect to their corresponding edges. The sheets are formed of a suitable polymeric film material, such as polytetrafluoroethylene, and are heat sealed to one another at edge regions thereof, including top heat seal 105, bottom heat seal 106, and side heat seals 103 and 104. The front panel of the inner liner has joined thereto a fitment 102, by means of which liquid or other material can be introduced into the interior compartment for containment therein. The fitment 102 may be formed of perfluoroalkoxy (PFA) resin or other suitable material.

FIG. 12 is a front elevation view of an outer liner 110, comprising an assembly 111 of two superposed sheets of polymeric film that are in register with one another with respect to their corresponding edges. The sheets are formed of suitable polymeric film material, such as polyethylene or other polyolefin material, and are heat sealed to one another at edge regions thereof, including bottom heat seal 115 and side seals 113 and 114. The front panel of the outer liner has a port fitment 112 that is configured to cooperatively mate with the fitment 102 of the inner liner (FIG. 11). The fitment 112 may be formed of high-density polyethylene, or other suitable material of construction.

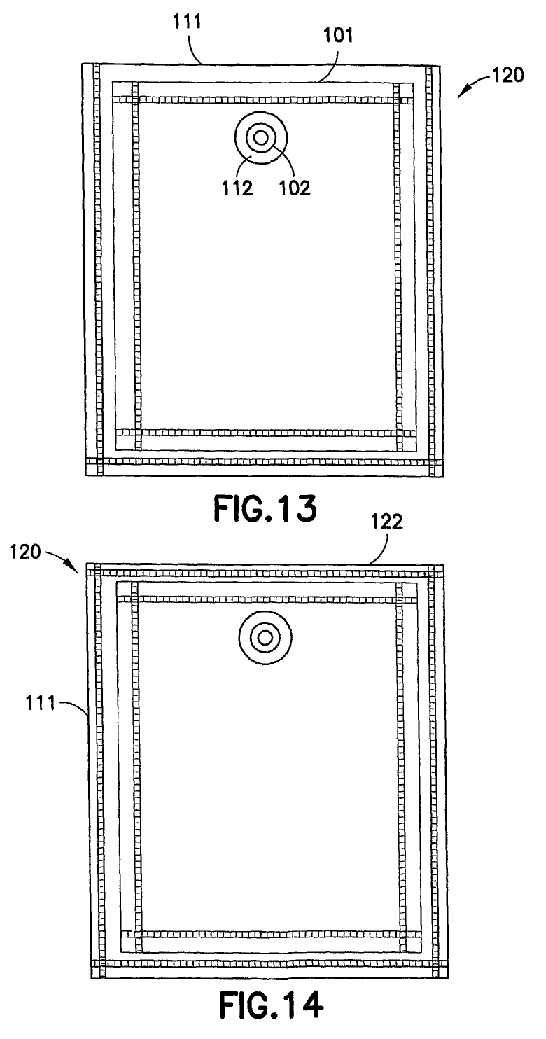

FIG. 13 is a front elevation view of the double liner structure including inner liner assembly 101 (of FIG. 11) positioned inside outer liner assembly 111 (of FIG. 12), with the fitment 102 of the inner liner cooperatively mated with the fitment 112 of the outer liner.

FIG. 14 is a front elevation view of the finished double liner assembly 120, in which the front and back polymeric film panels of the outer liner assembly have been heat sealed to one another along top heat seal 122, and air has been removed from the space between the inner and outer liners. The space between the inner and outer liners may subsequently be filled with a gas beneficial to contents of the inner liner, or otherwise constituting a desired barrier gas in such space, as discussed hereinabove.

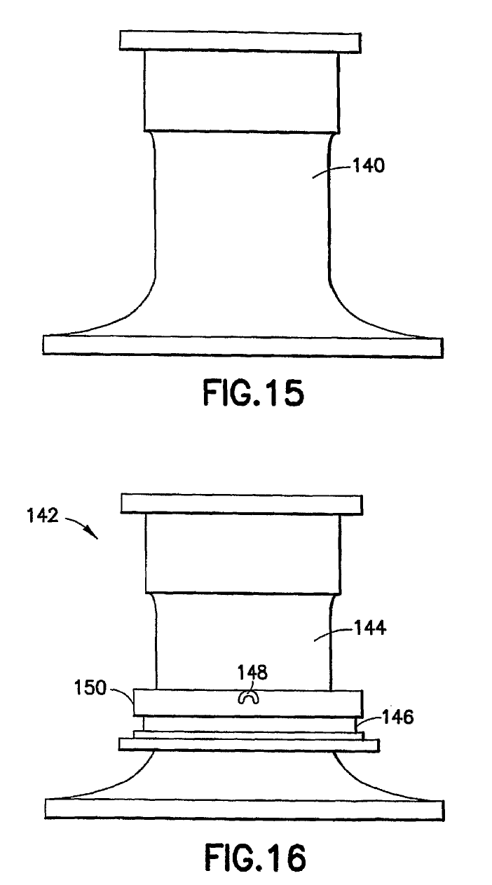

FIG. 15 is a front elevation view of a standard fitment 140, of a type which may be augmented as shown in FIG. 16. FIG. 16 shows a standard fitment body 144 that has been modified to constitute augmented fitment 142, by the provision of a collar 150, featuring an O-ring groove 146 therein, and hemispherical locktabs 148 integrally formed with the collar.

The collar 150 may be formed as a separate piece that is subsequently bonded or otherwise secured to the standard fitment 144, e.g., by ultrasonic welding, solvent welding, adhesive bonding, or other mode of attachment, to form the augmented fitment 142. Alternatively, the collar 150 may be integrally cast or molded as part of the fitment 142.

The collar is formed with three hemispherical locktabs 148 (only one is visible in FIG. 16) around the periphery of the collar, which cooperatively made with the outer liner fitment described more fully hereinafter.

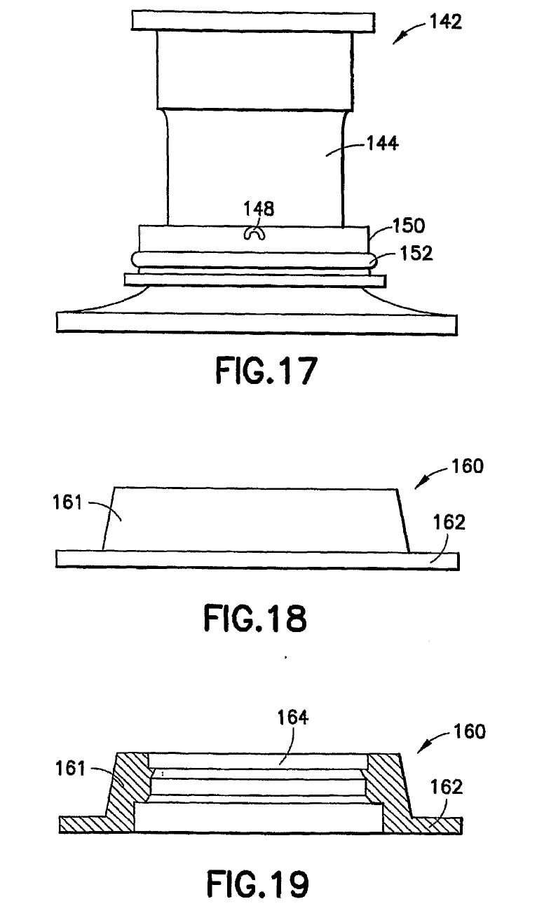

FIG. 17 is an elevation view of the augmented fitment 142 of FIG. 8, with O-ring 152 disposed in the O-ring groove 146 (see FIG. 16). The O-ring is added after the fitment 142 is welded to the inner liner (not shown in FIG. 17; see FIG. 11).

FIG. 18 is an elevation view of the outer liner fitment 160 including the central axle section 161 and peripheral flange 162 extending radially outwardly from the lower portion of axle section 161.

FIG. 19 is an elevation view, in cross-section, of the outer liner fitment 160 of FIG. 18, showing the central axle section 161 as circumferentially bounding the central bore 164, and the peripheral flange 162 extending radially outwardly from the lower portion of the axle section 161.

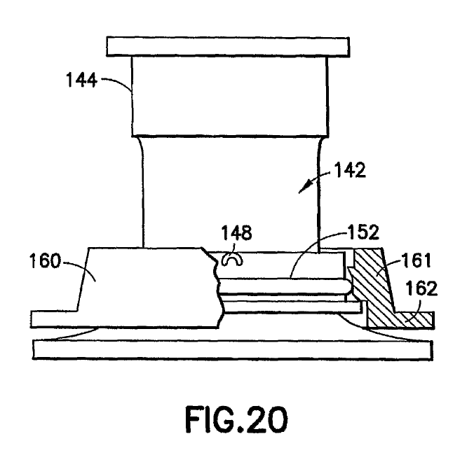

FIG. 20 is an elevation view, in partial cut-away and cross-section, of the completed fitment 142 as including the standard fitment 144 to which the collar has been mounted as described in connection with FIGS. 16 and 17. The standard fitment 144 therefore constitutes a lower flange portion to which the inner liner is welded, and a main cylindrical portion that circumscribes a central bore for introduction of material into the inner liner, or dispensing of material from such inner liner.

The peripheral flange 162 of the outer liner fitment is welded to the outer liner (not shown in FIG. 20) and the outer liner fitment then is snap-fitted over the inner liner fitment 142, so that the O-ring 152 provides a link-tight seal, and so that the hemispherical locktabs 148 secure the axle section 161 on the outer liner fitment 160 in sealed position.

By such cooperative arrangement of the respective inner liner and outer liner fitment members, a fitment assembly is provided on the liner-within-a-liner containment structure, which seals the space between the inner liner and outer liner and permits gas introduced into such space before the snap-fit sealing of the respective fitments to one another to be sealingly retained in such space, e.g., as a barrier or stabilizing medium, to protect or extend the shelf life of the material contained in the inner liner.

Subsequently, at the point of use, the fluid in the space between the inner liner and outer liner is suitably evacuated, e.g., by uncoupling the outer liner fitment from the inner liner fitment and applying pressure to the outer surface of the outer liner, to collapse the outer liner against the inner liner, to place the liner assembly in a state whereupon further application of pressure will effect the pressure-dispensing of the contained material from the interior volume of the inner liner through the inner liner fitment 142.

The above-described liner assembly can be disposed in an overpack, which may be constituted as a rigid outer container, and the pressure-dispensing operation may be conducted with introduction of gas into the space between the overpack and the outer liner of the liner assembly.

The double-liner and double-fitment structure described in connection with FIGS. 11-20 therefore permits a highly efficient containment of material for storage, transport and dispensing, and enables a barrier or protective medium to be interposed in the space between the inner and outer liners, as part of a package in which the liner assembly is disposed in the interior volume of an outer containment vessel.

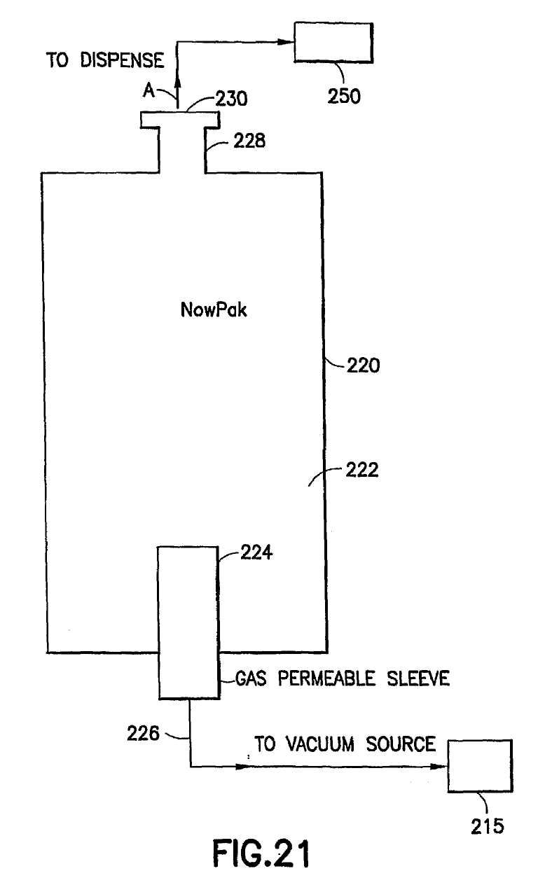

Another aspect of the invention relates to a composite liner 220 as schematically shown in FIG. 21, comprising a primary liner 222 attached at its upper end to fitment 228 having flange 230 at its distal end, for dispensing of fluid from the liner in the direction indicated by arrow A to a downstream semiconductor manufacturing facility 250 comprising a semiconductor manufacturing tool utilizing such fluid. The primary liner 220 is arranged as shown, with a secondary liner 224 penetrating the wall of the primary liner 222, whereby a portion of the secondary liner 224 is interiorly disposed in the primary liner 222, in the interior volume thereof.

The secondary liner 224 constitutes a gas-permeable sleeve in the portion thereof that is interiorly disposed in the primary liner 222, with such sleeve being gas-permeable but liquid-impermeable, whereby gases in the liquid or headspace in the primary liner 222 can be extracted through the gas-permeable portion of the secondary liner 224, when the secondary liner 224 is coupled with a suitable vacuum source (not shown in FIG. 21) by means of the vacuum suction line 226.

By applying vacuum suction on the interior sleeve portion of the secondary liner 224, dissolved and entrained gases will be extracted from the liquid in the primary liner 222, to suppress the formation of the microbubbles in the liquid, as well as in downstream flow circuitry and components due to pressure drop of dispensed liquid along the dispensing path. The gas-permeable sleeve portion of the secondary liner 224 preferably is permeable to atmospheric gases, as well as the pressurizing gas that is used for pressure-dispensing of the liquid from the primary liner 222.

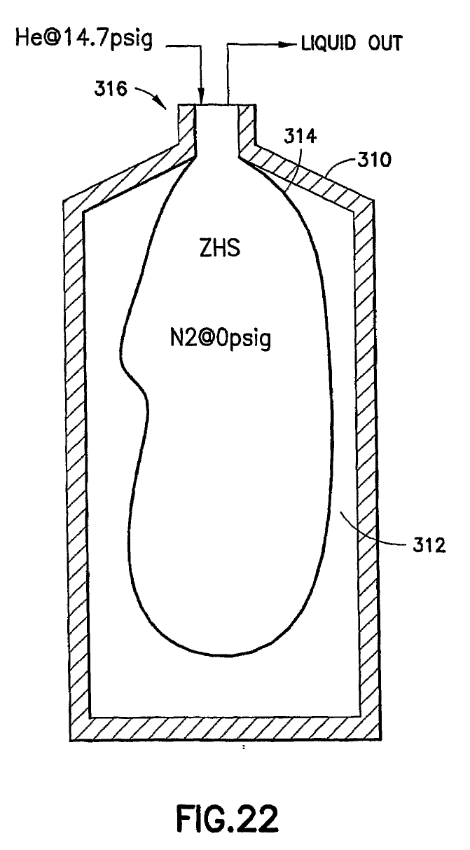

Another aspect of the invention relates to a liner-based package as schematically shown in FIG. 22, as comprising a rigid outer container 310 enclosing an interior volume 312 within which it is disposed a liner 314 suspended from the neck 316 of the vessel.

In typical practice, the liners are filled with liquid in an ambient nitrogen or ambient air environment, which results in correspondingly nitrogen-saturated or air-saturated liquid, over a wide range of saturation. If this liquid is highly saturated, then even minor fluctuations in temperature or pressure conditions can result in the formation of bubbles in the liquid. Such bubble formation susceptibility is increased if nitrogen or clean dry air are used to pressurize the annular space between the liner in the rigid outer container, since the net flux of gas from the annular space into the bag further increases the amount of dissolved gas in the liquid.

The present invention addresses this deficiency, by utilizing a gas in the annular space that is different from the gas in the ambient environment at the time of filling of the liner with liquid. By utilizing a different gas in the annular space, a concentration gradient is established that results in dissolved and entrained gas in the liquid diffusing through the liner into the annular space between the liner in the container. Such outgoing permeation of gases from the liquid through the liner into the annular space reduces the concentration of the original gas species in the liquid, and thereby decreases the susceptibility of the liquid to form microbubbles.

Thus, by way of example, the liner may be filled with liquid in the first instance, under nitrogen atmosphere, as a result of which the liquid is at least partially saturated with nitrogen. If helium gas then it is introduced into the annular space between the liner in the container, then the nitrogen in the liquid will diffuse through the liner and enter the annular space containing helium. While a corresponding concentration gradient will be established for the helium in the annular space, resulting in its diffusing through the liner into the liquid contained therein, the rate of such diffusion will be low and a significant period of time will be required for the helium to reach saturation conditions in the liquid in the liner.

It will be appreciated that the specific gases may be selected, to constitute the ambient environment when the liquid is being filled into the liner, and to constitute the different gas with which the annular space of the liner-based package is filled after the liquid filling operation has been completed.

FIG. 22 thus shows helium at 14.7 psig being filled into the annular space 312 of the liner-based package, and the liquid in the liner being in a zero headspace (“ZHS”) or near-zero headspace conformation, saturated with nitrogen at 0 psig as a result of the liquid fill operation taking place under inert nitrogen atmosphere. FIG. 22 also shows liquid being flowed out of the liner (“Liquid Out”), which may occur when the helium gas is introduced to the annular space in interior volume 312, to establish the zero headspace or near-zero headspace conformation, or subsequently at the point of the use, when helium gas may be introduced as a driver gas for pressure-dispensing of the liquid. Thus, the different gas species in the annular space may be employed as a “packing” or “fill” gas at the time of liquid package preparation, and the same or another different gas may be employed as the drive gas for pressure-dispensing.

Although the foregoing discussion has been directed to the use of single component gases in the liquid and in the annular space of the liner-based package, it will be appreciated that the originally packaged liquid may contain multiple gas species as dissolved and/or entrained components in the liquid, and likewise that the gas employed in the annular space of the liquid containment package may be a multicomponent gas.

The invention therefore contemplates the use of a gas medium in the annular space between the liner and the container that effects diffusional extraction of the dissolved and entrained gases from the liquid through the liner, to minimize the formation of the microbubbles and/or the effervescing of the liquid as the liquid pressure declines in the dispensing operation, in the flow circuitry and components associated there with (e.g., pumps, restricted flow orifice elements, etc.).

The gas medium in the annular space of the liner-based package desirably is a gas mixture, since the concentration of gas in the liquid within the liner can only rise to a maximum concentration equal to its concentration in the annular space gas, so the in-permeating gas from the annular space into the liquid will be below its saturation pressure.

As another approach for suppressing the formation of microbubbles and they contained the liquid, the ambient environment during filling of the liner with liquid can be constituted by a mixture of gases that all are all present at low mole fraction in the ambient gas mixture. The individual gases are each desirably present in the ambient gas mixture at levels that are below their saturation pressures under use (dispensing) conditions.

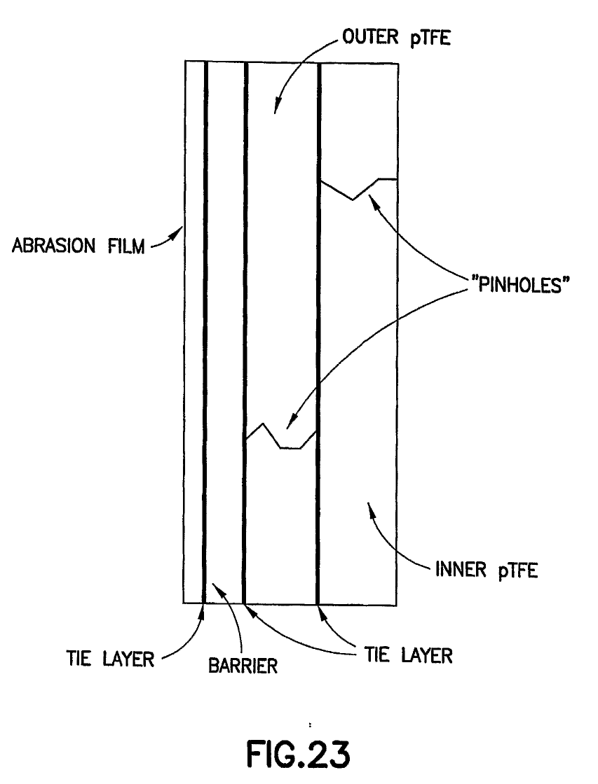

FIG. 23 is a sectional elevation view of a multilayer laminate useful in the general practice of the present invention for construction of liners adapted for use in liner-based material containment packages.

As illustrated, the multilayer laminate includes an innermost polytetrafluoroethylene (PTFE) layer, having a tie layer on its outer face, intermediate the innermost PTFE layer and the next adjacent outer PTFE layer. The outer layer instead of PTFE may be constituted by other fluoropolymer or polymeric film.

On the outer face of the outer layer of PTFE is a second tie layer, intermediate the outer PTFE layer and the next adjacent barrier layer. The barrier layer on its outer face has a third tie layer, intermediate the barrier layer and the outermost abrasion film layer.

The multilayer laminate thus includes seven successive layers, including in sequence (from the innermost layer to the outermost layer) a PTFE layer, a first tie layer, a PTFE layer, a second tie layer, a barrier layer, a third tie layer and an abrasion film layer.

The first tie layers function to seal successive PTFE layers to one another, so there is no path to allow movement of liquids through the seal between these two successive layers. Since PTFE in thin-film form is susceptible to the presence of pinholes, as illustrated in the FIG. 23 drawing, the use of two PTFE layers on either side of the first tie layer serves to dead-end the pinholes in the respective layers of PTFE, since there is a low probability that pinholes in the first and second PTFE layers will be aligned with one another.

In the multilayer laminate, the innermost PTFE layer is the liquid-contacting layer of the laminate, and therefore such layer is desirably highly inert in character. If the tie layer is formed of a highly inert material, then the tie layer can replace the inner PTFE layer.

It is very important to prevent liquid from reaching the barrier layer of the laminate, in order to maintain the liquid fully contained within the liner. The fabrication material of the barrier layer is selected based on desired properties for such layer. Barrier layer materials of construction include any suitable materials, but in preferred practice, such materials typically fall into three classes: metals, e.g., aluminum; ceramics, e.g., glass; and polymers with high barrier properties, e.g., EVOH, polyamide (nylon), polyvinylidene chloride (PVDC), polychlorotrifluoroethylene (PCTFE), polyether-ether-ketone (PEEK) and liquid crystal polymer (LCP).

The considerations involved in the material selection for the barrier layer include factors such as the following; ease of manufacturing; potential for contamination of liner contents; ease of formation; weldability; susceptibility to pinholing, particularly when flexed; and permeability to gases, water and the material to be retained in the liner, among others. The second tie layer is disposed between the outer PTFE layer and the barrier layer.

Additional barrier layers may be employed in the laminate to provide specific blocking of diffusion of particular species.

The outermost layer in the multilayer laminate is an abrasion film. The third tie layer is disposed between the barrier layer and the abrasion film. The purpose of the abrasion film layer is to protect the barrier layer from damage, as well as to prevent contamination deriving from the barrier layer, e.g., when the barrier layer is of a potentially contaminating material such as aluminum.

The abrasion film may be formed of any suitable material that is effective to protect the other layers in the laminate. Examples of illustrative materials that may be utilized to form the abrasion film in the broad practice of the present invention include, without limitation, fluoropolymers, polyethylene, polypropylene, polyether-ether-ketone (PEEK), etc.

The thicknesses of the layers in the multilayer laminate shown in FIG. 23 may be any suitable thicknesses that are effective to provide good performance by the laminate. In a specific embodiment, the inner PTFE layer has a thickness in a range of from about 0.25 to about 5 mils, the first tie layer has a thickness in a range of from about 0.1 to about 0.4 mils, the outer PTFE layer has a thickness in a range of from about 0.25 to about 5 mils, the second tie layer has a thickness in a range of from about 0.1 to about 0.4 mils, the barrier layer has a thickness in a range of from about 0.25 to about 5 mils, the third tie layer has a thickness in a range of from about 0.1 to about 0.4 mils, and the abrasion film layer has a thickness in a range of from about 0.25 to about 5 mils. In such embodiment, each of the tie layers can be formed of fluorocarbon adhesives, polyethylene adhesives or other adhesives, such as acrylics, cyanoacrylates, polyamines, epoxies, hot-melt adhesives, polyurethanes, and silicones. The barrier layer in such embodiment can be formed of aluminum, ceramics, EVOH, polyamide (nylon), polyvinylidene chloride (PVDC), polychlorotrifluoroethylene (PCTFE), polyether-ether-ketone (PEEK), liquid crystal polymer (LCP), or other suitable material.

The abrasion film in such embodiment can be formed of fluoropolymers, polyethylene, polypropylene, polyether-ether-ketone (PEEK), or other suitable material.

The liner-based packages of the invention can include a vessel, in which the liner is disposed, formed of any suitable material of construction, such as plastics, polymers, ceramics, metals, composite materials, etc. In applications where pressurizing gas is introduced into the interior volume of the vessel, exterior to the liner disposed therein, to effect pressure-dispensing of the materials contained in the liner, the vessel is constructed of material that accommodates the stresses of the pressures involved in progressively compacting the liner to force the material from the liner through the dispensing passages of the package.

In applications in which the pressure of the pressurizing gas for pressure-dispensing of the liner contents is substantial, e.g., on the order of 10 psig and above, it generally is preferred to employ vessels that are constructed of metal. Any suitable metals may be employed for such purpose, including steel or other ferrous alloy materials, titanium, brass, copper, etc. A particularly preferred metal material for the vessel, based on weight and cost considerations, is aluminum.

The invention in another aspect relates to a liner-based package in which the vessel in which the liner is disposed utilizes a first liner for containment of the material to be dispensed, and a second liner for a pressurizing fluid, which is selectively inflatable to exert pressure on the first liner during pressure-dispensing of the material from the first liner. In such arrangement, the vessel, as an overpack containing the first and second liners, can be vented and at ambient pressure conditions, or it may alternatively be at a subatmospheric pressure allowing the first liner to de-gas its contents so that any entrained gas content of the material in the first liner is extracted from the material in the first liner.

The advantages of such material-containing liner/pressurizing liner arrangement include the ability to optimize the liner materials of construction so that the chemical reagent or other contents of the package can be stored and subsequently dispensed at high purity, without formation of microbubbles and without the presence of dissolved gases therein.

In this respect, liner materials such as polytetrafluoroethylene and other fluoropolymers are desirable for maintaining high purity in storing chemical reagents and other substances that must be supplied at zero or near-zero contaminant concentrations, but such polymers exhibit poor gas barrier behavior. Although this poor gas barrier characteristic is overcome in the use of multilayer laminate liners, e.g., in which polytetrafluoroethylene is used in combination with plies of material having good gas barrier character, to provide a multilayer liner having acceptable gas barrier qualities, such multilayer liners suffer from problems of gas entrapment between layers in the laminate, contamination susceptibility from adhesives used to bond or tie successive layers in the laminate to one another, and reduced ability of the laminate to accommodate processing steps necessary to form the liner, such as where layers of material providing good gas barrier character have low melting points and constrain bonding or other processing operations needed to form the liner article.

The use of separate liners, one containing the material to be stored in and subsequently dispensed from the package, and one or more other pressure-dispensing liners, adapted to exert pressure on the storage liner during dispensing, resolves such problems of the multilayer laminate liners. The “contents” liner, containing the chemical reagent or other material to be dispensed, is inflated, filled and connected for pressure dispensing in a normal manner. The “pressurizing” liner is thus outside of and functionally separate from the contents liner, and may be formed of an inexpensive material of construction, such as an inexpensive single layer polyethylene film, such no stringent barrier properties are required for such liner.

At the point of use, the second (pressurizing) liner can be inflated, e.g., by pressurized air or other suitable gas or liquid. As the pressurizing liner is inflated, it applies force against the exterior surface of the first (contents) liner, to force the contents to be dispensed from first liner. The pressure of the pressurizing medium in the second liner therefore may be modulated as necessary to effect dispensing of contents from the first liner in the desired amount and at the desired rate.

Throughout such dispensing operation, the air in the vessel, outside the two liners, remains at atmospheric pressure, as it is vented to the atmosphere, e.g., through a vent line, valve or port. As such, no pressure gas will permeate the first liner, and the contents of the first liner will remain at high purity and free of bubbles. Alternatively, the gas in the vessel outside the first and second liners may be at subatmospheric or superatmospheric pressure. For example, the interior volume of the vessel may be subjected to vacuum to effect outgassing of any entrained gas in the first liner, by permeation thereof through the first liner. Alternatively, the interior volume of the vessel may be pressurized with a specific gas medium, to infuse such gas medium, e.g., an inert gas or protective gas, into the contents of the first liner during dispensing operation.

Thus, each of the first and second liners may be individually optimized for its respective individual function(s), so that the respective liners can be constituted of materials of construction appropriate to their use and at reduced cost, relative to the use of multilayer liners that require cost/performance compromises to be made in their design.

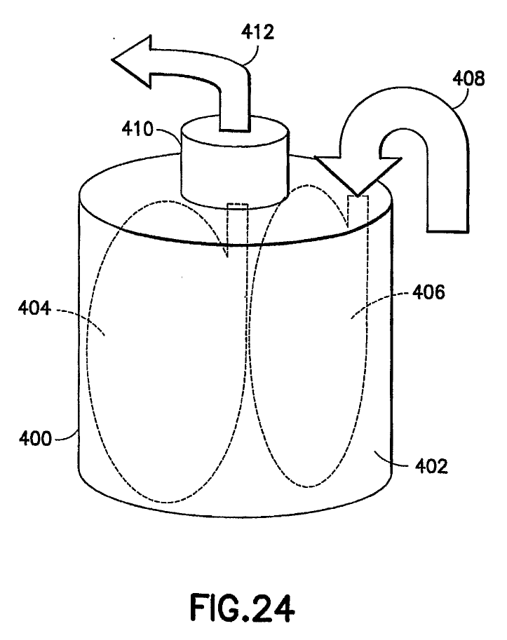

FIG. 24 is a perspective view of a liner-based package of a bag-in-bottle type, including a vessel 400 having a dispensing connector assembly 410 coupled thereto and arranged for dispensing material from the package, as generally indicated by dispensed material flow arrow 412. The vessel 400 in this package encloses an interior volume 402 in which is disposed a first liner 404 holding the material to be dispensed, and a second liner 406 that is inflated with a pressurizing gas whose flow is generally indicated by pressure gas inflow-arrow 408.

In operation, pressure gas is flowed into the second liner 406 to sufficient extent to inflate the second liner and cause it to exert pressure on the first liner 404 so that the first liner is progressively compacted under applied pressure and the material in the first liner is dispensed through the connector, e.g., to exterior flow circuitry or other apparatus for use of the dispensed material, e.g., an ultra-high purity photoresist for manufacture of a microelectronic product such as a semiconductor device, flat panel display, or the like. The vessel 400 may be vented so that the interior volume gas is displaced from the vessel as the inflation of the second liner 406 progresses (vent not shown in FIG. 24).

Although the package is illustratively shown in FIG. 24 as comprising only two liners, it will be appreciated that multiple pressurizing liners may be employed in specific embodiments of the invention, and that the liners may be of various shapes and conformations, as appropriate to their use. For example, the pressurizing liner may be formed with an annular conformation so that it circumscribes the first contents liner, as a sleeve thereon, so that pressure is applied circumferentially in a uniform radially inwardly fashion on the first liner in the dispensing operation.

It will also be appreciated that the second pressurizing liner, instead of being retained in the interior volume of the vessel in an uninflated condition prior to dispensing, may alternatively be partially or fully inflated to positionally secure the first liner in place in the interior volume, so as to avoid movement of the first liner in the interior volume during transport of the package and prior to dispensing operation. The second liner can thus be sealed at a pressure that positionally stabilizes the first liner in the package, and at the point of use, the second inner can be additionally initiated to an extent and at a rate appropriate for pressure dispense of the first liner contents.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

1-306. (canceled)

307. A material containment package including a first liner having an interior volume adapted to hold a first material therein in a sealed condition, and a second liner having an interior volume adapted to hold the first liner therein, wherein each of the first and second liners has a fitment allowing fluid communication with its interior volume, wherein the fitment of the first liner is coupleable with the fitment of the second liner to form a fitment assembly for the package.

308. The material containment package of claim 307, further including first material in the interior volume of the first liner, and a second material in the interior volume of the second liner, wherein said second material comprises:
(a) a gas that extends shelf life of the first material, in relation to shelf life of the first material in the absence of said gas; or
(b) a gas that provides a protective barrier against penetration of contaminant into the interior volume of the first liner.

309. The material containment package of claim 307, wherein the fitment assembly for the package is adapted to enable evacuation of the interior volume of the second liner outside of the first liner to accommodate pressure-dispensing of material from the first liner through the fitment of the first liner.

310. The material containment package of claim 307, wherein the first liner and the second liner are disposed in a container having a port in which the fitment assembly is mounted, wherein the container is adapted for introduction of drive gas into an interior volume thereof to effect pressure-dispensing of material from the first liner, to progressively compact the first and second liners for said pressure-dispensing.

311. The material containment package of claim 307, including a gas in the second liner outside of the first liner, wherein the first and second liners are substantially impermeable to said gas.

312. The material containment package of claim 307, comprising a vacuum passage in fluid communication with a space defined between the first liner and the second liner, and adapted to permit evacuation of said space.

313. The material containment package of claim 307, wherein the first and the second liner are disposed in a container having a port in which the fitment assembly is mounted, and the container is adapted for introduction of drive gas into an interior volume thereof to effect pressure-dispensing of material from the first liner, to progressively compact the first and second liners for said pressure-dispensing.

314. The material containment package of claim 307, wherein the first liner is formed of at least one sheet of polytetrafluoroethylene material heat sealed along edge regions thereof and coupled to said fitment of the first liner, and said the second liner is formed of at least one sheet of polyolefin material heat sealed along edge regions thereof and coupled to said fitment of the second liner.

315. The material containment package of claim 307, wherein the fitment of the first liner comprises an upper generally cylindrical main body portion and a lower outwardly flaring skirt portion defining a flange for liner securement, and a collar intermediate said generally cylindrical main body portion and said outwardly flaring skirt portion, wherein said collar includes a circumferentially extending groove accommodating placement therein of an O-ring, and said collar includes at least one locking element for securement thereto of the fitment of the second liner.

316. A composite liner including a primary liner attached at an upper end thereof to a fitment providing material introduction and removal communication with an internal volume of the primary liner, and a secondary liner partially penetrating and secured to the primary liner with a penetrated portion of the secondary liner disposed in the internal volume of the primary liner, said secondary liner including a non-penetrating portion exterior of the primary liner, wherein said penetrated portion of the secondary liner is gas-permeable but liquid-impermeable.

317. A composite liner according to claim 316, wherein the non-penetrating portion of the secondary liner is adapted to be coupled to a vacuum source for extraction of dissolved and entrained gas from liquid when a liquid is contained in the primary liner.

318. A composite liner according to claim 316, wherein the penetrated portion of the secondary liner is permeable to air.

319. A composite liner according to claim 316, wherein the liner is adapted for pressure-dispensing of the liquid from the primary liner, by a drive gas, and the penetrated portion of the secondary liner is permeable to said drive gas.

320. A fluid storage and dispensing package, comprising:
a vessel having an interior volume;
a liner in said interior volume, arranged to contain a liquid medium;
a flexible, inflatable bladder in said interior volume, said bladder being inflatable with a fluid medium to contact and retain the liner in position when the liner contains a liquid medium; and
a gas removal compartment arranged in restricted fluid penetration communication with said interior volume of said vessel, and adapted to remove gas from the interior volume of the vessel when the liner contains liquid medium and the bladder is inflated.

321. The fluid storage and dispensing package of claim 320, wherein the bladder is inflated with an inert gas, and the liner contains liquid medium.

322. The fluid storage and dispensing package of claim 320, wherein the gas removal compartment is formed at least in part of a material that is permeable to passage of gas into the compartment.

323. The fluid storage and dispensing package of claim 320, wherein the gas removal compartment contains a getter.

324. The fluid storage and dispensing package of claim 320, wherein the compartment is adapted for evacuation of gas therefrom, and adapted for maintenance of an evacuated state during containment of liquid medium in the liner.

325. The fluid storage and dispensing package of claim 320, wherein the bladder is adapted to be inflated to a first inflation state to contact and retain the liner in position when the liner contains a liquid medium during transportation and storage of the vessel, and the bladder is adapted to be inflated to a second inflation state to compress the liner for dispensing of the liquid medium therefrom during dispensing operation of the package.

326. The fluid storage and dispensing package of claim 320, further comprising a dispensing assembly adapted for engagement with the vessel to dispense liquid medium therefrom, the dispensing assembly including a dispense head and a dip tube coupled thereto.

327. A liquid medium storage and dispensing package, comprising a container having an interior volume for holding liquid medium, said container including a semi-flexible portion that is shape-shiftable to vary size of said interior volume available to hold the liquid medium, whereby the interior volume is selectively variable between an expanded volumetric state providing a greater head space for said liquid medium and a compacted volumetric state providing a smaller head space for said liquid medium.

328. The liquid medium storage and dispensing package of claim 327, wherein the shape-shiftable semi-flexible portion is manually deformable.

329. The liquid medium storage and dispensing package of claim 327, wherein the liquid medium comprises high purity microelectronic device manufacturing reagent, and wherein the semi-flexible portion is constructed and arranged so that absolute pressure in the container does not approach the vapor pressure of the high purity microelectronic device manufacturing reagent when the interior volume is in said compacted volumetric state.

330. A polymeric film laminate, comprising an inner ply formed of high purity medium density polyethylene, and an outer ply including seven film layers comprising successively a first layer, adjacent the inner ply, of linear low density polyethylene and medium density polyethylene including an anti-block agent, a first tie layer of anhydride-modified polyethylene adjacent the first layer, a first polyamide layer adjacent the anhydride-modified polyethylene tie layer, an EVOH layer adjacent the first polyamide layer, a second layer of polyamide adjacent the EVOH layer on a side thereof opposite the side adjacent the first polyamide layer, a second tie layer of anhydride-modified polyethylene adjacent the second polyamide layer, and a layer of linear low density polyethylene and high density polyethylene including an anti-block agent.

331. The polymeric film laminate of claim 330, wherein the thickness of the outer ply of the laminate is from 2 to 4 mils, and the overall thickness of the laminate including the inner ply thereof, is from 5 to 6 mils.
